(19) United States
(12) Patent Application Publication
(10) Pub. No.: US 2023/0162171 A1
(43) Pub. Date: May 25, 2023

(54) COMMODITY STORAGE SUPPORT DEVICE AND PROGRAM

(71) Applicant: TOSHIBA TEC KABUSHIKI KAISHA, Tokyo (JP)

(72) Inventor: Nobuyuki Marumo, Izu Shizuoka (JP)

(21) Appl. No.: 17/851,105

(22) Filed: Jun. 28, 2022

(30) Foreign Application Priority Data
Nov. 19, 2021 (JP) 2021-188718

(51) Int. Cl. G06Q 20/20

(52) U.S. Cl. CPC G06Q 20/203; G06Q 20/202

(57) ABSTRACT

A server device (a commodity storage support device) includes a commodity-information acquiring unit configured to acquire information relating to storage of registered commodities, a storage-body-information acquiring unit configured to acquire information relating to a storage body for storing commodities purchased by a customer, a storage-method calculating unit configured to calculate a storage method in storing the commodities in the storage body, and a storage-method output unit (an information presenting unit) configured to output, in a displayable manner, the storage method to a portable terminal carried by the customer.

### CROSS-REFERENCE TO RELATED APPLICATION

This application is based upon and claims the benefit of priority from Japanese Patent Application No. 2021-188718, filed on Nov. 19, 2021, the entire contents of which are incorporated herein by reference.

### FIELD

Embodiments described herein relate generally to a commodity storage support device and a program.

### BACKGROUND

There has been known a technique for, if purchased commodities are stored in a register bag or a reusable shopping bag, supporting storage work by presenting a storage method for the commodities. Specifically, a calculated storage method is presented to a store clerk at a register. There has also been known an example in which a storage method is presented to a customer who is performing settlement in a self-service register.

### DESCRIPTION OF THE DRAWINGS

FIG. 1 is a diagram illustrating a configuration example of a commodity storage support system according to a first embodiment;

FIG. 2 is a hardware block diagram illustrating an example of a hardware configuration of a server device included in the commodity storage support system;

FIG. 3 is a hardware block diagram illustrating an example of a hardware configuration of a POS terminal included in the commodity storage support system;

FIG. 4 is a hardware block diagram illustrating an example of a hardware configuration of a portable terminal included in the commodity storage support system;

FIG. 5 is a functional block diagram illustrating an example of a functional configuration of the server device;

FIG. 6 is a functional block diagram illustrating an example of a functional configuration of the POS terminal;

FIG. 7 is a functional block diagram illustrating an example of a functional configuration of the portable terminal;

FIG. 8 is a diagram illustrating an example of the configuration of a commodity master;

FIG. 9 is a diagram illustrating an example of the configuration of a register bag master;

FIG. 10 is a diagram illustrating an example of the configuration of a member master;

FIG. 11 is a diagram illustrating an example of a screen on which a customer selects a storage body that the customer uses in a POS terminal;

FIG. 12 is a diagram illustrating an example of information indicating storage order and a storage position of commodities displayed on the portable terminal;

FIG. 13 is a flowchart illustrating an example of a flow of processing performed by the commodity storage support system;

FIG. 14 is a diagram illustrating a configuration example of a commodity storage support system according to a second embodiment;

FIG. 15 is an exterior view illustrating an example of a shopping cart included in the commodity storage support system;

FIG. 16 is a hardware block diagram illustrating an example of a hardware configuration of a cart terminal included in the shopping cart;

FIG. 17 is a functional block diagram illustrating an example of a hardware configuration of a virtual POS server included in the commodity storage support system;

FIG. 18 is a functional block diagram illustrating an example of a hardware configuration of a checkout machine included in the commodity storage support system;

FIG. 19 is a functional block diagram illustrating an example of a functional configuration of the cart terminal;

FIG. 20 is a functional block diagram illustrating an example of a functional configuration of the virtual POS server;

FIG. 21 is a functional block diagram illustrating an example of a functional configuration of the checkout machine;

FIG. 22 is a functional block diagram illustrating an example of a functional configuration of an electronic receipt server included in the commodity storage support system;

FIG. 23 is a flowchart illustrating an example of a flow of processing performed by the commodity storage support system;

FIG. 24 is a diagram illustrating a configuration example of a commodity storage support system according to a third embodiment;

FIG. 25 is a diagram for explaining a state in which a store clerk stores, in a basket, commodities registered in a POS terminal included in the commodity storage support system;

FIG. 26 is a diagram for explaining a method of calculating a storage method for commodities;

FIG. 27 is a functional block diagram illustrating an example of a functional configuration of the POS terminal;

and

FIG. 28 is a flowchart illustrating an example of a flow of processing performed by the commodity storage support system.

### DETAILED DESCRIPTION

In the storage support in the related art, since the storage method for the commodities is presented in the register, the store clerk or the customer needs to store the commodities in the register. Therefore, customers waiting for their turns in the register are likely to stay in a queue. In view of such a situation, there has been demanded a method capable of presenting, to the customer, a storage method in a place away from the register, for example, in a sacker table.

An aspect of embodiments is to, in order to solve the problems described above, provide a commodity storage support device and a program that can present, to a customer who purchases commodities, in a place where the customer stores the commodities, a storage method for the commodities in a storage body.

A commodity storage support device according to an embodiment includes a commodity-information acquiring unit, a storage-body-information acquiring unit, a storage-method calculating unit, and an information presenting unit. The commodity-information acquiring unit acquires information relating to storage of registered commodities. The storage-body-information acquiring unit acquires information relating to a storage body for storing commodities purchased by a customer. The storage-method calculating unit calculates a storage method in storing the commodities in the storage body. The information presenting unit outputs, in a displayable manner, the storage method to a portable terminal carried by the customer.

### First Embodiment

A commodity storage support system 1 according to a first embodiment is explained with reference to the drawings.

(System Configuration of the Commodity Storage Support System)

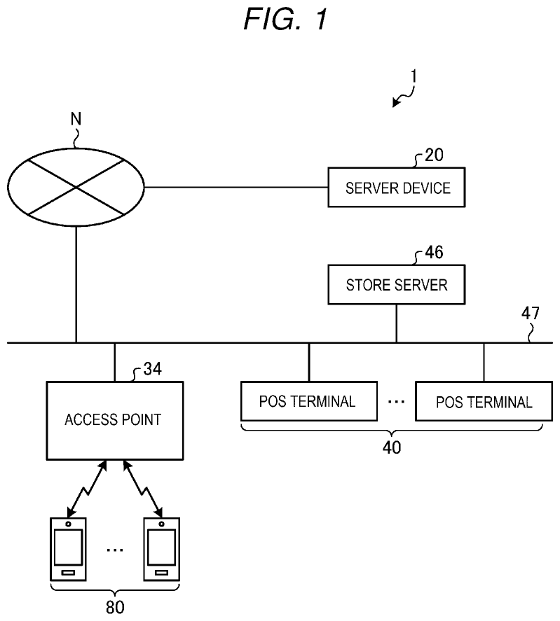

A system configuration of the commodity storage support system 1 is explained with reference to FIG. 1. FIG. 1 is a diagram illustrating a configuration example of the commodity storage support system according to the first embodiment.

The commodity storage support system 1 presents a storage method to a customer if the customer stores commodities purchased in a store in a register bag or a reusable shopping bag. The commodity storage support system 1 includes a server device 20, POS terminals 40 and a store server 46 set in the store, and portable terminals 80 carried by customers. It is assumed that the customers doing shopping are members of an electronic receipt system who can receive, with the portable terminals 80, as a computerized receipt, settlement information relating to commodities for which settlement is completed.

The server device 20 generates electronic receipt information based on settlement information transmitted from the POS terminal 40. The server device 20 outputs the generated electronic receipt information to the portable terminal 80 of a customer who did shopping relating to the settlement information. The server device 20 acquires storage body information of a storage body used for storage of commodities by the customer and calculates a method of storing purchased commodities in the storage body. The server device 20 outputs the calculated storage method to the portable terminal 80 of the customer. The server device 20 is an example of the commodity storage support device in the present disclosure. The generation of the electronic receipt information and the calculation of the storage method may be performed by different server devices. However, in this embodiment, it is assumed that the generation of the electronic receipt information and the calculation of the storage method are performed by the same server device 20.

The server device 20 performs communication with the POS terminal 40 and the portable terminals 80 via a network N.

The POS terminal 40 performs registration processing for registering commodities to be purchased by the customer and settlement processing for performing settlement relating to the registered commodities. In this embodiment, it is assumed that the POS terminal 40 configures a face-to-face type register. However, this embodiment can also be applied to a semi-self-service register with which the registration processing for commodities is performed face-to-face and a customer himself or herself performs the settlement processing or a self-service register with which the customer himself or herself performs all of the registration processing and the settlement processing for the commodities.

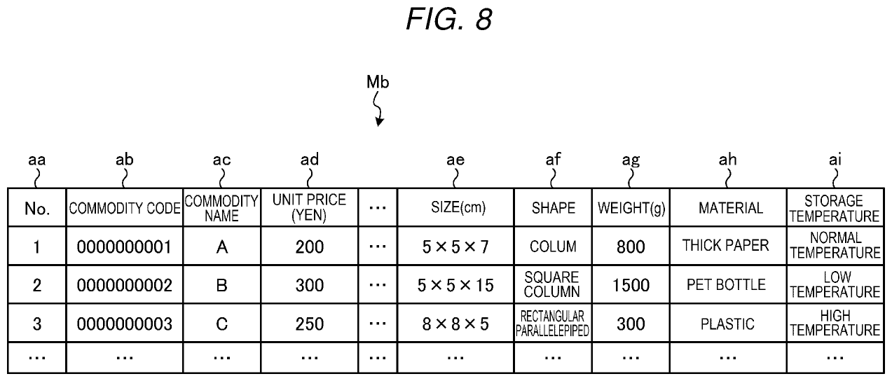

The store server 46 manages the operations of a plurality of POS terminals 40 set in the store. The store server 46 acquires the latest commodity master Mb (see FIG. 8) from a not-illustrated host server and outputs the latest commodity master Mb to the POS terminals 40. Further, the store server 46 aggregates settlement information generated by the POS terminals 40 to thereby store the settlement information as sales information of the store.

The portable terminal 80 is carried by the customer and stores member information of the electronic receipt system. The portable terminal 80 acquires the electronic receipt information and the storage method for the purchased commodities from the server device 20. Further, the portable terminal 80 displays the acquired electronic receipt information and the acquired storage method for the commodities according to operation of the customer. Specifically, the portable terminal 80 is a smartphone, a tablet terminal, a personal computer, or the like.

The POS terminal 40 and the store server 46 are connected by an in-store network 47. The portable terminal 80 performs communication with the server device 20 via an access point 34 connected to the in-store network 47.

(Hardware Configuration of the Server Device)

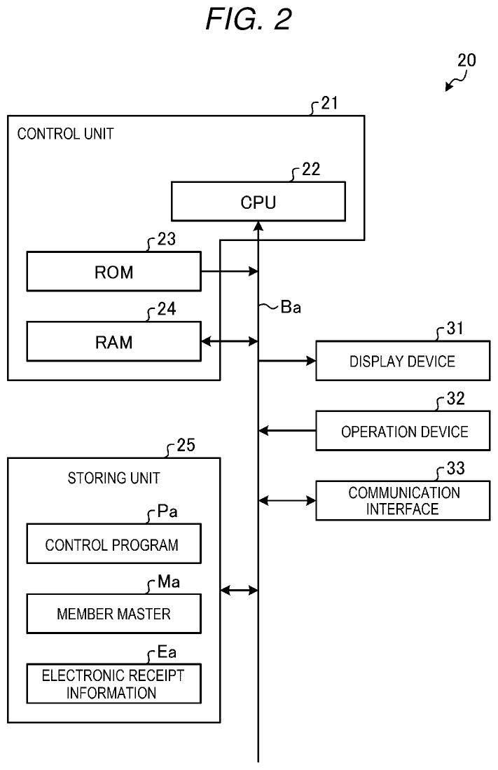

A hardware configuration of the server device 20 is explained with reference to FIG. 2. FIG. 2 is a hardware block diagram illustrating an example of a hardware configuration of the server device included in the commodity storage support system according to the first embodiment.

The server device 20 includes a control unit 21 for controlling units of the server device 20. The control unit 21 includes a CPU (Central Processing Unit) 22, a ROM (Read Only Memory) 23, and a RAM (Random Access Memory) 24. The CPU 22 is connected to the ROM 23 and the RAM 24 via an internal bus Ba such as an address bus or a data bus. The CPU 22 loads, in the RAM 24, various programs stored in the ROM 23 and a storing unit 25. The CPU 22 operates according to the various programs loaded in the RAM 24 to control the server device 20. That is, the control unit 21 has the configuration of the general computer.

The control unit 21 is connected to the storing unit 25, a display device 31, an operation device 32, and a communication interface 33 via the internal bus Ba.

The storing unit 25 is a storage device such as a HDD (Hard Disk Drive) or an SSD (Solid State Drive). The storing unit 25 may be a nonvolatile memory such as a flash memory in which stored information is retained even if the server device 20 is turned off. The storing unit 25 stores a control program Pa, a member master Ma, and electronic receipt information Ea.

The control program Pa is a program for controlling the operation of the entire server device 20.

The member master Ma stores attribute information such as member codes of a plurality of members capable of using the electronic receipt system, mail addresses of the portable terminals 80 carried by the members, and reusable shopping bag information used in shopping. These kinds of information are information registered by the members. The member master Ma is explained in detail below (see FIG. 10).

The electronic receipt information Ea is electronic receipt information generated based on a result of the settlement processing performed by the POS terminal 40. The electronic receipt information Ea includes commodity information of sold commodities, content of the settlement, and information concerning the store where the settlement is performed.

The display device 31 displays a screen generated according to an instruction of the control unit 21. The display device 31 is configured by a device such as an LCD (Liquid Crystal Display) or an organic EL (Electro-Luminescence) display.

The operation device 32 acquires input operation of an operator and transmits the input operation to the control unit 21. The operation device 32 is configured by a device such as a touch panel or a keyboard.

The communication interface 33 is an interface for communicating with the POS terminal 40 and the portable terminal 80 via wireless communication by a wireless LAN or the like or wired communication by a wired LAN or the like.

### (Hardware Configuration of the POS Terminal)

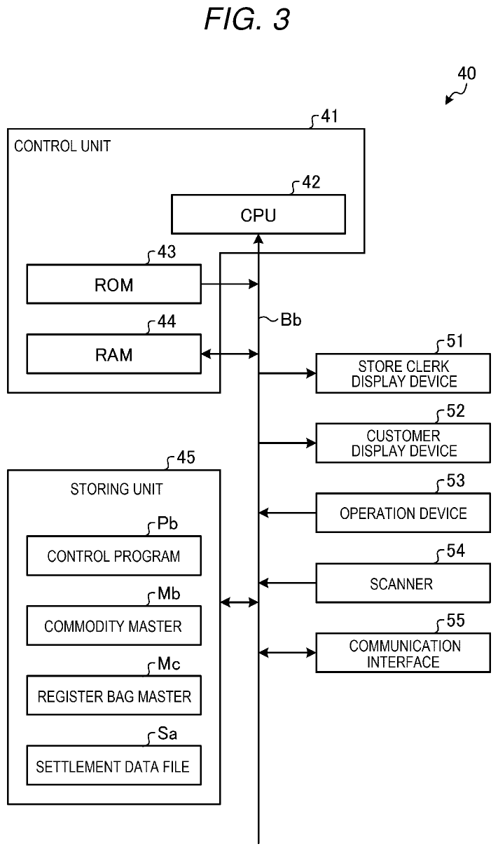

A hardware configuration of the POS terminal 40 is explained with reference to FIG. 3. FIG. 3 is a hardware block diagram illustrating an example of a hardware configuration of the POS terminal included in the commodity storage support system according to the first embodiment.

The POS terminal 40 includes a control unit 41 for controlling units. The control unit 41 includes a CPU 42, a ROM 43, and a RAM 44. The CPU 42 is connected to the ROM 43 and the RAM 44 via an internal bus Bb such as an address bus or a data bus. The CPU 42 loads, in the RAM 44, various programs stored in the ROM 43 and a storing unit 45. The CPU 42 operates according to the various programs loaded in the RAM 44 to control the POS terminal 40. That is, the control unit 41 has the configuration of the general computer.

The control unit 41 is connected to the storing unit 45, a store clerk display device 51, a customer display device 52, an operation device 53, a scanner 54, and a communication interface 55 via the internal bus Bb.

The storing unit 45 is a storage device such as a HDD or an SSD. The storing unit 45 may be a nonvolatile memory such as a flash memory in which stored information is retained even if the POS terminal 40 is turned off. The storing unit 45 stores a control program Pb, a commodity master Mb, a register bag master Mc, and a settlement data file Sa.

The control program Pb is a program for controlling the operation of the entire POS terminal 40.

The commodity master Mb is a master file in which commodity information of commodities sold in the store is stored. The commodity information includes commodity names of the commodities, information relating to settlement of prices and the like, and information relating to storage such as sizes and weights of the commodities. The commodity master Mb is explained in detail below (see FIG. 8). Since content of the commodity master Mb is updated at any time, the POS terminal 40 acquires the latest commodity master Mb from, for example, the store server 46.

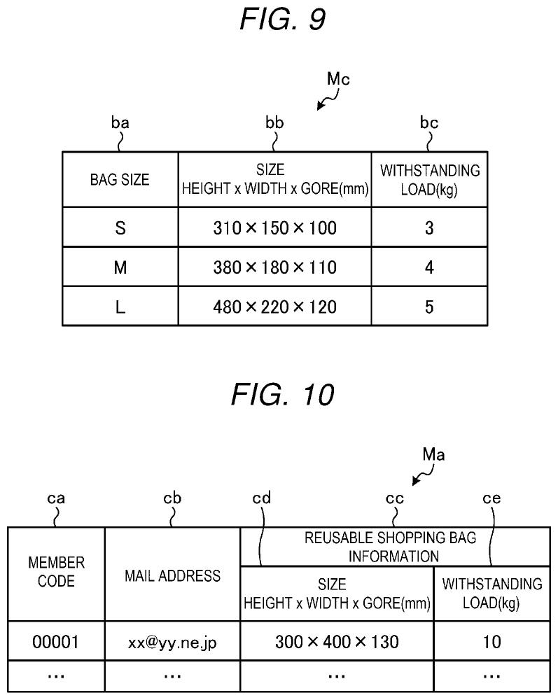

The register bag master Mc is a master file in which information relating to sizes of register bags sold in the store is stored. The register bag master Mc is explained in detail below (see FIG. 9).

The settlement data file Sa is a file indicating settlement content generated based on the settlement processing performed by the POS terminal 40. The settlement data file Sa is stored as sales information of the store and transmitted to the store server 46 and accumulated at timing, for example, after a business end of the store.

The store clerk display device 51 displays, to a store clerk, a screen generated according to an instruction of the control unit 41. The store clerk display device 51 is configured by a device such as an LCD or an organic EL display.

The customer display device 52 displays, to a customer, a screen generated according to an instruction of the control unit 41. The customer display device 52 is configured by a device such as an LCD or an organic EL display.

The operation device 53 acquires input operation of an operator and transmits the input operation to the control unit 41. The operation device 53 is configured by a device such as a keyboard or a touch panel. The operation device 53 may be provided on both of the store clerk side and the customer side.

If the customer registers a commodity to be purchased, the scanner 54 reads code information (for example, a barcode) stuck to or printed on the commodity. The scanner 54 reads code information including member information displayed on the portable terminal 80 of the customer.

The communication interface 55 is an interface for communicating with the server device 20 and the store server 46 via wireless communication by a wireless LAN or the like or wired communication by a wired LAN or the like.

The store server 46 in this embodiment is only a repeater used if the server device 20 and the POS terminal 40 perform communication and an aggregator for the settlement data file Sa generated by the POS terminal 40. Therefore, explanation of a hardware configuration of the store server 46 is omitted.

(Hardware Configuration of the Portable Terminal)

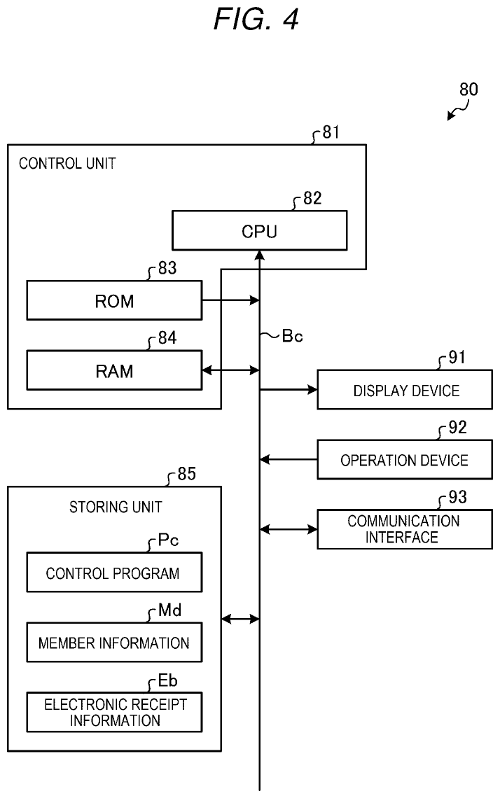

A hardware configuration of the portable terminal 80 is explained with reference to FIG. 4. FIG. 4 is a hardware block diagram illustrating an example of a hardware configuration of the portable terminal included in the commodity storage support system according to the first embodiment.

The portable terminal 80 includes a control unit 81 for controlling units. The control unit 81 includes a CPU 82, a ROM 83, and a RAM 84. The CPU 82 is connected to the ROM 83 and the RAM 84 via an internal bus Bc such as an address bus or a data bus. The CPU 82 loads, in the RAM 84, various programs stored in the ROM 83 and a storing unit 85. The CPU 82 operates according to the various programs loaded in the RAM 84 to control the portable terminal 80. That is, the control unit 81 has the configuration of the general computer.

The control unit 81 is connected to the storing unit 85, a display device 91, an operation device 92, and a communication interface 93 via the internal bus Bc.

The storing unit 85 is a storage device such as a HDD or an SSD. The storing unit 85 may be a nonvolatile memory such as a flash memory in which stored information is retained even if the portable terminal 80 is turned off. The storing unit 85 stores a control program Pc, member information Md, and electronic receipt information Eb.

The control program Pc is a program for controlling the operation of the entire portable terminal 80.

The member information Md is, for example, a member code necessary for using the electronic receipt system.

The electronic receipt information Eb is electronic receipt information indicating a result of settlement processing performed at the time when a user of the portable terminal 80 purchases commodities. The electronic receipt information Eb is transmitted from the server device 20 to the portable terminal 80 and stored.

The display device 91 displays a screen generated according to an instruction of the control unit 81. The display device 91 is configured by a device such as an LCD or an organic EL display.

The operation device 92 acquires input operation of an operator and transmits the input operation to the control unit 81. The operation device 92 is configured by a device such as a keyboard or a touch panel.

The communication interface 93 is an interface for communicating with the server device 20 via wireless communication by a wireless LAN or the like.

(Functional Configuration of the Server Device)

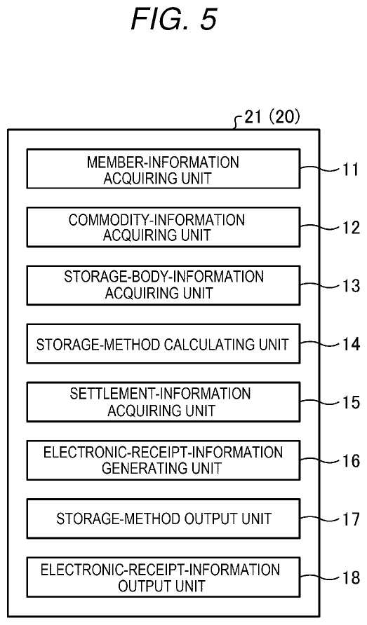

A functional configuration of the server device 20 is explained with reference to FIG. 5. FIG. 5 is a functional block diagram illustrating an example of a functional configuration of the server device included in the commodity storage support system according to the first embodiment.

The control unit 21 of the server device 20 loads the control program Pa in the RAM 24 and causes the control program Pa to operate to thereby realize, as functional units, a member-information acquiring unit 11, a commodity-information acquiring unit 12, a storage-body-information acquiring unit 13, a storage-method calculating unit 14, a settlement-information acquiring unit 15, an electronic-receipt-information generating unit 16, a storage-method output unit 17, and an electronic-receipt-information output unit 18 illustrated in FIG. 5.

The member-information acquiring unit 11 acquires, from the POS terminal 40, member information (for example, a member code) of a customer who performed settlement.

Every time a commodity is registered, the commodity-information acquiring unit 12 acquires, from the POS terminal 40, commodity information of the registered commodity. The commodity information to be acquired includes information relating to storage of the registered commodity.

The storage-body-information acquiring unit 13 acquires, from the POS terminal 40, information relating to a storage body that is designated by the customer and in which purchased commodities are stored. Specifically, the storage-body-information acquiring unit 13 acquires information indicating whether the purchased commodities are stored in a reusable shopping bag or stored in a purchased register bag or both of the reusable shopping bag and the register bag are used.

The storage-method calculating unit 14 calculates a size of a register bag necessary for storing commodities, commodity information of which is acquired by the commodity-information acquiring unit 12 to that point, and a storage method for the commodities. The storage-method calculating unit 14 calculates a method of storing settled commodities in a storage body, storage body information of which is acquired by the storage-body-information acquiring unit 13.

The settlement-information acquiring unit 15 acquires, from the POS terminal 40, settlement information indicating content of the settlement.

The electronic-receipt-information generating unit 16 generates computerized receipt information, that is, electronic receipt information based on the settlement information acquired by the settlement-information acquiring unit 15. The electronic-receipt-information generating unit 16 stores the generated electronic receipt information in the storing unit 25.

Every time a commodity is registered, the storage-method output unit 17 outputs, in a displayable manner, to the POS terminal 40, a storage method for storing commodities registered to that point. The storage-method output unit 17 outputs, in a displayable manner, to the portable terminal 80 of the customer, a method of storing settled commodities in a designated storage body (a reusable shopping bag of the customer, a purchased register bag, or both of the reusable shopping bag and the register bag). The storage-method output unit 17 is an example of the information presenting unit in the present disclosure.

The electronic-receipt-information output unit 18 outputs the electronic receipt information to the portable terminal 80 of the customer.

(Functional Configuration of the POS Terminal)

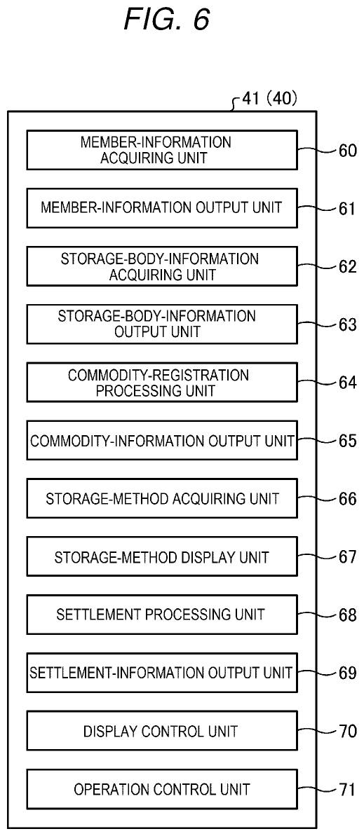

A functional configuration of the POS terminal 40 is explained with reference to FIG. 6. FIG. 6 is a functional block diagram illustrating an example of a functional configuration of the POS terminal included in the commodity storage support system according to the first embodiment.

The control unit 41 of the POS terminal 40 loads the control program Pb in the RAM 44 and causes the control program Pb to operate to thereby realize, as functional units, a member-information acquiring unit 60, a member-information output unit 61, a storage-body-information acquiring unit 62, a storage-body-information output unit 63, a commodity-registration processing unit 64, a commodity-information output unit 65, a storage-method acquiring unit 66, a storage-method display unit 67, a settlement processing unit 68, a settlement-information output unit 69, a display control unit 70, and an operation control unit 71 illustrated in FIG. 6.

The member-information acquiring unit 60 receives the member information Md of the electronic receipt system from the portable terminal 80 of the customer. Specifically, the POS terminal 40 reads, with the scanner 54, code information including the member information Md displayed on the display device 91 of the portable terminal 80. The member information Md may be transmitted and received by wireless communication between the portable terminal 80 and the POS terminal 40.

The member-information output unit 61 outputs the acquired member information Md to the server device 20.

The storage-body-information acquiring unit 62 acquires, according to operation of the store clerk based on an instruction of the customer, information relating to a storage body used by the customer. The information relating to the storage body used by the customer is information indicating whether the customer stores a commodity in a register bag or stores the commodity in a reusable shopping bag or uses both of the register bag and the reusable shopping bag.

The storage-body-information output unit 63 outputs the acquired storage body information to the server device 20.

The commodity-registration processing unit 64 performs registration processing for reading, with the scanner 54, code information of a barcode or the like attached to a commodity to be purchased by the customer to thereby register the commodity.

The commodity-information output unit 65 outputs commodity information of the commodity registered by the commodity-registration processing unit 64 to the server device 20.

The storage-method acquiring unit 66 acquires, from the server device 20, a size of a register bag necessary for storing commodities registered at that point in time and a storage method for the commodities in the register bag.

The storage-method display unit 67 displays, on the customer display device 52, the storage method for commodities registered to that point, the storage method being acquired by the storage-method acquiring unit 66.

The settlement processing unit 68 performs, on a total amount of the commodities registered by the commodity-registration processing unit 64, settlement processing based on a payment method designated by the customer. The settlement processing unit 68 generates the settlement data file Sa indicating a result of the settlement and stores the settlement data file Sa in the storing unit 45.

The settlement-information output unit 69 outputs settlement information indicating the result of the settlement by the settlement processing unit 68 to the server device 20.

The display control unit 70 generates a display screen to be displayed on the store clerk display device 51 or the customer display device 52 of the POS terminal 40. The display control unit 70 outputs the generated display screen to the store clerk display device 51 or the customer display device 52.

The operation control unit 71 acquires operation information of operation performed by the operation device 53 of the POS terminal 40 and passes the operation information to the control unit 41. The control unit 41 causes the POS terminal 40 to perform control corresponding to the acquired operation information.

(Functional Configuration of the Portable Terminal)

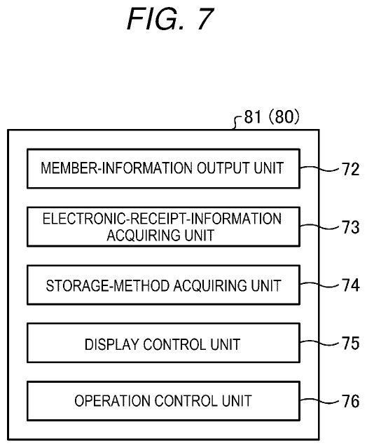

A functional configuration of the portable terminal 80 is explained with reference to FIG. 7. FIG. 7 is a functional block diagram illustrating an example of a functional configuration of the portable terminal included in the commodity storage support system according to the first embodiment.

The control unit 81 of the portable terminal 80 loads the control program Pc in the RAM 84 and causes the control program Pc to operate to thereby realize, as functional units, a member-information output unit 72, an electronic-receipt-information acquiring unit 73, a storage-method acquiring unit 74, a display control unit 75, and an operation control unit 76 illustrated in FIG. 7.

The member-information output unit 72 transmits the member information Md relating to the use of the electronic receipt system to the POS terminal 40. The member-information output unit 72 may display, on the display device 91 of the portable terminal 80, code information of a barcode or the like including the member information Md. The member-information output unit 72 may transmit the member information Md to the POS terminal 40 by wireless communication.

The electronic-receipt-information acquiring unit 73 acquires electronic receipt information from the server device 20.

The storage-method acquiring unit 74 acquires a storage method for purchased commodities from the server device 20.

The display control unit 75 generates a display screen to be displayed on the display device 91 of the portable terminal 80. The display control unit 75 outputs the generated display screen to the display device 91.

The operation control unit 76 acquires operation information of operation performed by the operation device 92 of the portable terminal 80 and passes the operation information to the control unit 81. The control unit 81 causes the portable terminal 80 to perform control corresponding to the acquired operation information.

(Data Structure of the Commodity Master)

A data structure of the commodity master Mb is explained with reference to FIG. 8. FIG. 8 is a diagram illustrating an example of the configuration of the commodity master.

The commodity master Mb is a master file in which attribute information of all commodities sold in the store is recorded. The attribute information includes at least information relating to settlement and information relating to storage.

Specifically, the commodity master Mb records the information relating to settlement and the information relating to storage together with serial numbers aa given to the commodities.

As the information relating to settlement, for example, a commodity code ab, a commodity name ac, and a unit price ad illustrated in FIG. 8 are recorded. The commodity code ab is an identification code such as a JAN code for uniquely specifying a commodity. The commodity name ac is a name given to the commodity. The unit price ad is a price per one commodity. The information relating to settlement is not limited to the foregoing. Besides, for example, a classification name of the commodity may be recorded. The information relating to settlement recorded in the commodity master Mb is used if the POS terminal 40 performs registration processing and settlement processing.

As the information relating to storage, for example, a size ae, a shape af, a weight ag, a material ah, and a storage temperature ai illustrated in FIG. 8 are recorded. The size ae is information for specifying a volume occupied by a commodity. The size ae is represented by, for example, a size of length x width x depth. The shape af is information representing an external shape of the commodity. The shape af is represented by a name such as column, square column, or rectangular parallelepiped. The weight ag is information for specifying the weight of the commodity. The material ah is information for specifying the material of the commodity. The material ah is represented by a name such as thick paper, PET bottle, or plastic. The storage temperature ai is information for specifying a desired storage temperature for the commodity. The storage temperature ai is represented by a name such as normal temperature, low temperature, or high temperature. The information relating to storage is not limited to the foregoing. Besides, a storage posture (sideways toppling unallowable or the like), loading information (stacking prohibited), and the like may be recorded. The information relating to storage recorded in the commodity master Mb is used if the server device 20 calculates a storage method for commodities.

(Data Structure of the Register Bag Master)

A data structure of the register bag master Mc is explained with reference to FIG. 9. FIG. 9 is a diagram illustrating an example of the configuration of the register bag master.

The register bag master Mc is a master file in which specifications of register bags that can be purchased in the store are recorded. Specifically, the register bag master Mc records a bag size ba, a size bb, a withstanding load bc.

The bag size ba is information for specifying a size of a register bag. The bag size ba is represented by, for example, signs of S, M, and L. The size bb is information for specifying a dimension of the register bag. The size bb is represented by, for example, a size of height X width X gore. The withstanding load bc is information for specifying a withstanding load of the register bag. The withstanding load bc is represented by a numerical value representing the withstanding load. The information recorded in the register bag master Mc is used if the server device 20 calculates a storage method for commodities.

(Data Structure of the Member Master)

A data structure of the member master Ma is explained with reference to FIG. 10. FIG. 10 is a diagram illustrating an example of the configuration of the member master.

The member master Ma is a master file in which member information of the electronic receipt system is recorded. Specifically, the member master Ma records a member code ca, a mail address cb, and reusable shopping bag information cc.

The member code ca is an identification number for uniquely specifying a member of the electronic receipt system.

The mail address cb is, for example, a mail address for transmitting guidance information relating to shopping to a member. Usually, a mail address of the portable terminal 80 carried by the member is registered as the mail address cb. A member of the electronic receipt system operates a dedicated application such as an electronic receipt application installed in the portable terminal 80 of the member to thereby browse electronic receipt information created by the server device 20.

The reusable shopping bag information cc is information that records the size of a reusable shopping bag used in shopping by the member. The reusable shopping bag information cc includes a size cd and a withstanding load ce. The size cd is information for specifying the dimension of the reusable shopping bag. The size cd is represented by, for example, a size of height x width x gore. The withstanding load ce is information for specifying a withstanding load of the reusable shopping bag. The withstanding load ce is represented by a numerical value representing the withstanding load. The member himself or herself can register the size cd and the withstanding load ce by, for example, causing a member information registration application operating on the portable terminal 80 to operate. The information recorded in the member master Ma is used, for example, if the server device 20 outputs generated electronic receipt information or calculates a storage method for commodities or if the POS terminal 40 performs the checkout processing and the settlement processing.

Information recorded in the member master Ma is not limited to the information illustrated in FIG. 10. For example, attribute information such as age and sex and transmission possibility information concerning a guidance mail may be recorded.

(Method of Designating a Storage Body to be Used)

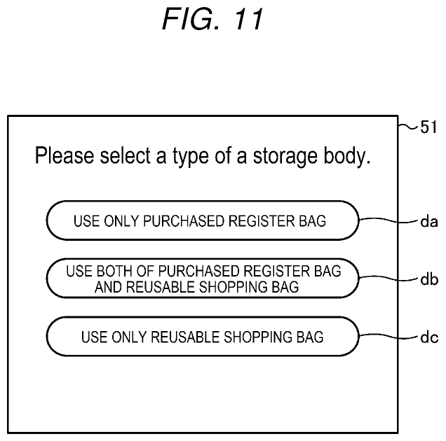

A method of designating a storage body for storing commodities is explained with reference to FIG. 11. FIG. 11 is a diagram illustrating an example of a screen for selecting a storage body used by a customer in the POS terminal.

FIG. 11 is a screen illustrating selection information for a storage body, the screen being displayed on the store clerk display device 51 of the POS terminal 40. A button da, a button db, and a button dc are displayed on the store clerk display device 51. The button da is a button for selecting use of only a purchased register bag. The button db is a button for selecting use of both of the purchased register bag and a reusable shopping bag. The button dc is a button for selecting use of only the reusable shopping bag.

All of the button da, the button db, and the button do are operation buttons of a touch panel stacked on a display surface of the store clerk display device 51. The store clerk asks the customer about a type of a storage body to be used and presses a button corresponding to the type of the storage body. Consequently, the type of the storage body to be used by the customer is selected.

If the customer is a member of the electronic receipt system, information concerning a reusable shopping bag used by the customer is recorded in the member master Ma in advance. Therefore, the server device 20 that receives an instruction from the POS terminal 40 can acquire reusable shopping bag information from the member master Ma of a customer corresponding to the instruction.

If the customer selects use of the purchased register bag, the server device 20 that receives an instruction from the POS terminal 40 can acquire specifications of the register bag to be used by the customer by collating a type of a register bag purchased in the POS terminal 40 with information recorded in the register bag master Mc.

In the example explained above, the store clerk asks the customer about the type of the storage body to be used and selects the storage body on the store clerk display device 51. However, a method of selecting a storage body is not limited to this. For example, the same screen as the screen illustrated in FIG. 11 may be output to the customer display device 52. The customer himself or herself may select a storage body.

(Method of Calculating a Storage Method)

A method of calculating a storage method for commodities performed by the server device 20 is explained. The server device 20 causes the control program Pa (see FIG. 2) to operate to thereby calculate a storage method for commodities in the storage body (only the purchased register bag is used, both of the purchased register bag and the reusable shopping bag are used, or only the reusable shopping bag is used) selected by the customer, the storage body information of the storage body being output by the POS terminal 40. The storage method for commodities includes storage order and a storage position.

The server device 20 acquires information relating to the storage body from the reusable shopping bag information registered in the member master Ma and the information for specifying the register bag purchased by the customer, the information being output from the POS terminal 40 to the server device 20. If the register bag is included in settlement information, the POS terminal 40 refers to the register bag master Mc (see FIG. 9) and outputs information (a size and a withstanding load) relating to the purchased register bag to the server device 20 together with the settlement information.

The server device 20 acquires, based on the settlement information output from the POS terminal 40 to the server device 20, information relating to a commodity that should be stored. The POS terminal 40 refers to the commodity master Mb (see FIG. 9) and outputs information relating to storage (a size, a shape, a weight, a material, and a storage temperature) relating to storage to the server device 20 together with the settlement information.

The storing unit 25 of the server device 20 may store the commodity master Mb and the register bag master Mc in advance. In this case, the POS terminal 40 only has to output the information relating to the storage body selected by the customer and the settlement information relating to the settlement of the commodity to the server device 20 and does not need to output the information relating to the register bag and the information concerning the storage of the commodity to the server device 20.

The server device 20 performs an AI analysis to thereby calculate storage order and a storage position of commodities. Specifically, the server device 20 calculates a storage method for the commodities referring to a knowledge database in which a plurality of kinds of knowledge relating to storage are recorded. As the knowledge database relating to storage, for example, knowledge, that is, desirable storage conditions described below are used.
(1) Store a heavier commodity in a lower part of the storage body.
(2) Store a harder commodity in a lower part of the storage body.
(3) Store a softer commodity in an upper part of the storage body.
(4) Store commodities without gaps as much as possible.
(5) Store commodities having the same storage temperature close to one another.
(6) Store commodities having different storage temperatures away from one another.
(7) Set a total of weights of commodities stored in the storage body within a range of a withstanding load of the storage body.
(8) Set a size covering the commodities stored in the storage body within a range of a size of the storage body.

The knowledge database may be expanded according to the information relating to storage recorded in the commodity master Mb. For example, if information indicating possibility of sideways-toppled storage of a commodity is recorded in the commodity master Mb, a knowledge database indicating that “a commodity that can be toppled sideways may be toppled sideways and stored” is additionally applied.

If given commodities are stored in the storage body, a publicly-known packing algorithm only has to be applied about a specific method of calculating optimum storage order and a storage position. Therefore, detailed explanation of the specific method is omitted.

(Display Method for a Storage Method)

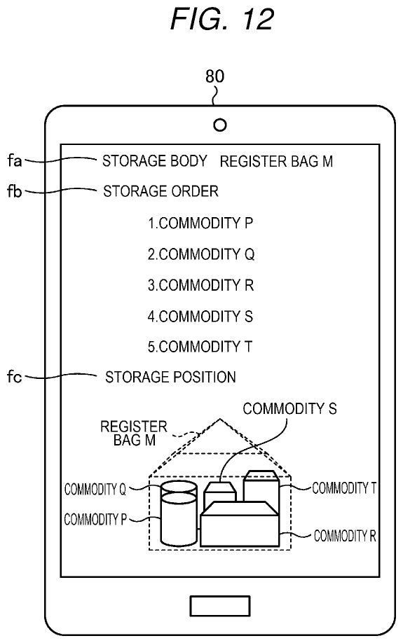

A display example of a storage method for commodities is explained with reference to FIG. 12. FIG. 12 is a diagram illustrating an example of information indicating storage order and a storage position of commodities displayed on a portable terminal.

As illustrated in FIG. 12, a storage method for commodities acquired from the server device 20 is displayed on the portable terminal 80 of the customer. Specifically, a type fa of a storage body, storage order fb, and a storage position fc are displayed.

The type fa of the storage body is information indicating a type of a storage body selected by the customer. The example illustrated in FIG. 12 indicates a case in which a register bag of a size M is selected.

The storage order fb is information indicating storage order of purchased commodities. The customer only has to perform storage in order from a first commodity.

The storage position fc is information indicating a state in which all commodities are stored in the register bag of the size M. In the storage position fc, a positional relation among bagged commodities is illustrated. Commodity names are given to the commodities to help storage of the commodities. The customer performs storage of the commodities on, for example, a sacker table (a work table) while viewing the storage order fb and the storage position fc displayed on the portable terminal 80 of the customer.

In FIG. 12, only the register bag is selected as the storage body. However, if use of both of a reusable shopping bag and the register bag as the storage body is selected, the storage order fb and the storage position fc are displayed for each of the reusable shopping bag and the register bag.

(Flow of Processing Performed by the Commodity Storage Support System)

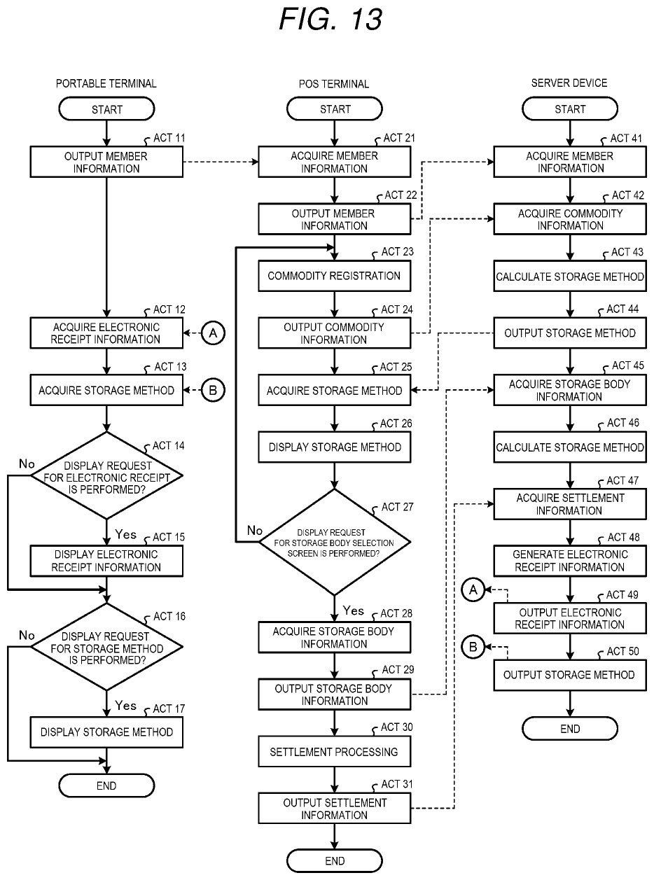

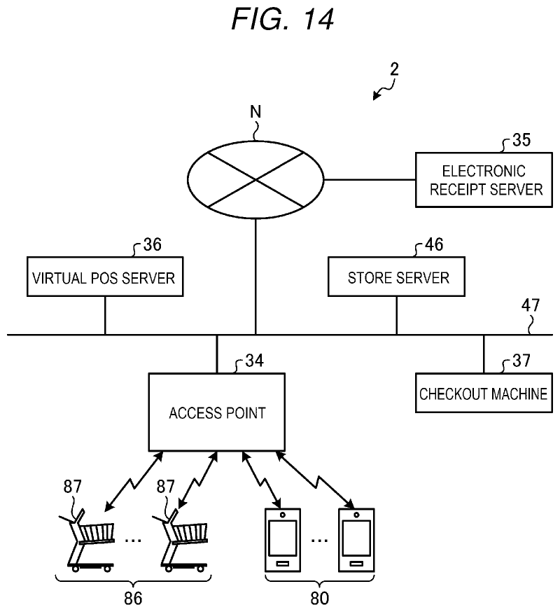

A flow of processing performed by the commodity storage support system 1 is explained separately for the portable terminal 80, the POS terminal 40, and the server device 20 with reference to FIG. 13. FIG. 13 is a flowchart illustrating an example of a flow of processing performed by the commodity storage support system according to the first embodiment.

(Flow of Processing Performed by the Portable Terminal)

The member-information output unit 72 outputs member information Md of the electronic receipt system to the POS terminal 40 (Act 11). As the output of the member information Md, an encoded member code may be displayed on the display device 91 of the portable terminal 80 or the member information Md may be transmitted from the portable terminal 80 to the POS terminal 40 by wireless communication.

If settlement ends, the electronic-receipt-information acquiring unit 73 acquires electronic receipt information from the server device 20 (Act 12). Specifically, the electronic-receipt-information acquiring unit 73 operates the dedicated application such as the electronic receipt application installed in the portable terminal 80 to thereby acquire the electronic receipt information from the server device 20 based on an identification code and a member code of the application.

Subsequently, the storage-method acquiring unit 74 acquires a storage method for commodities from the server device 20 (Act 13). The storage method for commodities may be simultaneously acquired when the electronic receipt information is acquired in Act 12. If the storage method for commodities is transmitted from the server device 20 to the portable terminal 80, the storage method for commodities may be attached to a mail or a link destination of the storage method for commodities stored in the server device 20 may be transmitted.

The operation control unit 76 determines whether a display request for an electronic receipt is performed by the operation device 92 of the portable terminal 80 (Act 14). If it is determined that the display request for the electronic receipt is performed (Yes in Act 14), the processing proceeds to Act 15. On the other hand, if it is not determined that the display request for the electronic receipt is performed (No in Act 14), the processing proceeds to Act 16.

If it is determined in Act 14 that the display request for the electronic receipt is performed, the display control unit 75 displays the electronic receipt information on the display device 91 of the portable terminal 80 (Act 15).

If it is not determined in Act 14 that the display request for the electronic receipt is performed or subsequent to Act 15, the operation control unit 76 determines whether a display request for a storage method is performed by the operation device 92 of the portable terminal 80 (Act 16). If it is determined that the display request for the storage method is performed (Yes in Act 16), the processing proceeds to Act 17. On the other hand, if it is not determined that the display request for the storage method is performed (No in Act 16), the portable terminal 80 ends the processing illustrated in FIG. 13.

If it is determined in Act 16 that the display request for the storage method is performed, the display control unit 75 displays a storage method for purchased commodities on the display device 91 of the portable terminal 80 (Act 17). The storage method for the commodities may be browsed by the dedicated application installed in the portable terminal 80. Thereafter, the portable terminal 80 ends the processing illustrated in FIG. 13.

(Flow of Processing Performed by the POS Terminal)

The member-information acquiring unit 60 acquires the member information Md of the customer from the portable terminal 80 (Act 21).

The member-information output unit 61 outputs the member information Md of the customer to the server device 20 (Act 22).

The commodity-registration processing unit 64 performs commodity registration processing for reading, with the scanner 54, code information of a barcode or the like attached to a commodity to be purchased by the customer and registering the commodity corresponding to the read code information (Act 23).

The commodity-information output unit 65 outputs commodity information of the commodity registered by the commodity-registration processing unit 64 to the server device 20 (Act 24).

The storage-method acquiring unit 66 acquires, from the server device 20, a size of a register bag necessary for storing commodities registered at that point in time and a storage method for the commodities in the register bag (Act 25).

The storage-method display unit 67 displays, on the customer display device 52, the size of the register bag necessary for storing the commodities registered at that point in time and the storage method for the commodities in the register bag (Act 26). By calculating and displaying the storage method every time a commodity is registered, if the customer purchases a register bag and stores commodities in the register bag, at a point in time when registration of the commodities to be purchased is completed, it is possible to grasp a size and the number of register bags capable of storing all the commodities. Therefore, by purchasing necessary register bags last, the customer can perform settlement processing for the commodities and the register bags at a time.

The operation control unit 71 determines whether the store clerk performs operation for requesting display of a selection screen for a storage body (see FIG. 11) on the store clerk display device 51 (Act 27). If it is determined that the operation for requesting the display of the selection screen for the storage body is performed (Yes in Act 27), the processing proceeds to Act 28. On the other hand, if it is not determined that the operation for requesting the display of the selection screen for the storage body is performed (No in Act 27), the processing returns to Act 23.

If it is determined in Act 27 that the operation for requesting the display of the selection screen for the storage body is performed, the storage-body-information acquiring unit 62 acquires storage body information of a storage body selected based on an instruction of the customer on the selection screen for the storage body (Act 28).

The storage-body-information output unit 63 outputs the acquired storage body information to the server device 20 (Act 29).

The settlement processing unit 68 performs, on a total amount of the commodities registered by the commodity-registration processing unit 64, settlement processing based on a payment method designated by the customer (Act 30). The settlement processing unit 68 generates the settlement data file Sa indicating a result of the settlement and stores the settlement data file Sa in the storing unit 45.

The settlement-information output unit 69 outputs settlement information indicating the result of the settlement to the server device 20 (Act 31). Thereafter, the POS terminal 40 ends the processing illustrated in FIG. 13.

If the reusable shopping bag information cc (see FIG. 10) is registered in the member information Md, after the member information Md is output to the server device 20 in Act 22, every time a commodity is registered, the POS terminal 40 may acquire and display a storage method in a reusable shopping bag calculated by the server device 20.

(Flow of Processing Performed by the Server Device)

The member-information acquiring unit 11 acquires the member information Md of the customer from the POS terminal 40 (Act 41).

The commodity-information acquiring unit 12 acquires commodity information of the registered commodities from the POS terminal 40 (Act 42).

The storage-method calculating unit 14 calculates a size of a register bag necessary for storing commodities, commodity information of which is acquired by the commodity-information acquiring unit 12 to that point, and a storage method for commodities (Act 43).

The storage-method output unit 17 outputs, in a displayable manner, the size of the register bag and the storage method for commodities calculated in Act 43 to the POS terminal 40 (Act 44).

The storage-body-information acquiring unit 13 acquires storage body information from the POS terminal 40 (Act 45).

The storage-method calculating unit 14 calculates a method of storing all of the registered commodities in a storage body, the storage body information of which is acquired by the storage-body-information acquiring unit 13 (Act 46).

The settlement-information acquiring unit 15 acquires settlement information from the POS terminal 40 (Act 47).

The electronic-receipt-information generating unit 16 generates electronic receipt information based on the settlement information acquired in Act 47 (Act 48). The electronic-receipt-information generating unit 16 stores the generated electronic receipt information in the storing unit 25.

The electronic-receipt-information output unit 18 outputs the generated electronic receipt information to the portable terminal 80 of the customer (Act 49).

The storage-method output unit 17 outputs, in a displayable manner, the storage method calculated in Act 46 to the portable terminal 80 (Act 50). Thereafter, the server device 20 ends the processing illustrated in FIG. 13. The electronic receipt information and the storage method are separately output to the portable terminal 80. However, the electronic receipt information and the storage method may be collected in one file and output.

(Action Effects of the First Embodiment)

As explained above, the server device 20 (the commodity storage support device) in the first embodiment includes the commodity-information acquiring unit 12 that acquires information relating to storage of registered commodities, the storage-body-information acquiring unit 13 that acquires information relating to a storage body for storing commodities purchased by a customer, the storage-method calculating unit 14 that calculates a storage method for storing the commodities in the storage body, and the storage-method output unit 17 (the information presenting unit) that outputs, in a displayable manner, the storage method to the portable terminal 80 carried by the customer. Therefore, the customer can store the commodities while checking the presented storage method. Consequently, it is possible to reduce congestion around a register and a sacker table.

In the server device 20 (the commodity storage support device) in the first embodiment, the storage method calculated by the storage-method calculating unit 14 includes the storage order and the storage position for storing commodities in the storage body. Therefore, it is possible to clearly present the storage method for the commodities.

In the server device 20 (the commodity storage support device) in the first embodiment, the storage-method output unit 17 (the information presenting unit) outputs the storage method and information indicating a settlement result of the commodities. Therefore, the customer can store the commodities at the customer's own pace while checking the information indicating the storage method, for example, on the sacker table.

In the server device 20 (the commodity storage support device) in the first embodiment, the storage body is a storage bag purchased by the customer or a reusable shopping bag carried by the customer. Therefore, the server device 20 can present a storage method corresponding to the storage body used by the customer.

### Second Embodiment

A commodity storage support system 2 according to a second embodiment is explained with reference to the drawings.

(System Configuration of the Commodity Storage Support System)

A system configuration of the commodity storage support system 2 is explained with reference to FIG. 14. FIG. 14 is a diagram illustrating a configuration example of the commodity storage support system according to the second embodiment.

The commodity storage support system 2 presents a storage method for purchased commodities to a customer who uses a so-called cart POS or smartphone POS with which the customer himself or herself is capable of performing registration processing and settlement processing for commodities purchased in a store. The commodity storage support system 2 includes an electronic receipt server 35, a virtual POS server 36, a store server 46, and a checkout machine 37 set in the store, the portable terminals 80 carried by customers, and shopping carts 86 pushed and moved by the customers in the store. The shopping carts 86 include cart terminals 87. It is assumed that a customer doing shopping is a member of an electronic receipt system who can receive, with the portable terminal 80, as computerized receipt, settlement information relating to a commodity for which settlement is completed.

The electronic receipt server 35 generates electronic receipt information based on settlement information transmitted from the checkout machine 37, the portable terminal 80, and the cart terminal 87. The electronic receipt server 35 outputs the generated electronic receipt information to the portable terminal 80 of a customer who did shopping relating to the settlement information.

The electronic receipt server 35 performs communication with the virtual POS server 36, the checkout machine 37, the portable terminal 80, and the cart terminal 87 via the network N.

The virtual POS server 36 acquires storage body information of a storage body used by the customer to store commodities and calculates a method of storing the commodities in the storage body. The virtual POS server 36 outputs the calculated storage method to the portable terminal 80 of the customer or the cart terminal 87. The virtual POS server 36 is an example of the commodity storage support device in the present disclosure. The virtual POS server 36 acquires settlement information indicating a result of settlement processing performed in the checkout machine 37, the portable terminal 80, and the cart terminal 87 and stores the settlement information as sales information of the store.

The checkout machine 37 is a terminal device that a customer using a cart POS or a smartphone POS uses, for example, in performing cash settlement. The checkout machine 37 includes a function of depositing and dispensing bills and coins relating to the cash settlement and a function of dispensing a paper receipt.

The store server 46 includes a function of a monitoring server that monitors operation states of a plurality of cart terminals 87 and the checkout machine 37 present in the store, the virtual POS server 36, and the like. The store server 46 acquires the latest commodity master Mb (see FIG. 8) from a not-illustrated host server and outputs the latest commodity master Mb to the cart terminals 87.

The virtual POS server 36, the store server 46, and the checkout machine 37 are connected by the in-store network 47. The portable terminal 80 and the cart terminal 87 perform communication with the electronic receipt server 35 and the virtual POS server 36 via the access point 34 connected to the in-store network 47.

In the commodity storage support system 2, a flow of processing performed by the cart POS including the cart terminal 87 and a flow of processing performed by the smartphone POS including the portable terminal 80 are the same. Therefore, an example is explained in which the commodity storage support system 2 is operated by the cart POS including the cart terminal 87.

(Configuration of the Cart Terminal)

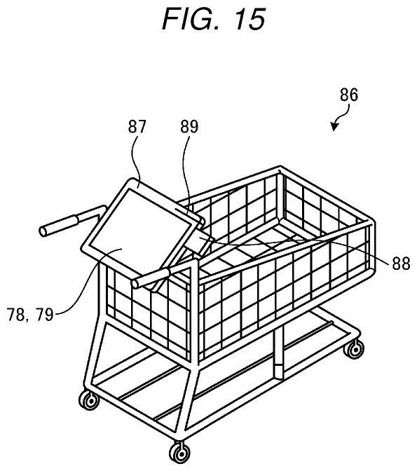

The configuration of the cart terminal 87 is explained with reference to FIG. 15. FIG. 15 is an exterior view illustrating an example of a shopping cart included in the commodity storage support system according to the second embodiment.

As illustrated in FIG. 15, the entire skeleton of the shopping cart 86 is configured by frames. The shopping cart 86 includes casters for movement and a handle gripped by a customer. Net sections are formed among the frames to form a storage section in which commodities to be purchased are stored.

The cart terminal 87 facing the side of the customer gripping the handle is attached near the handle via a holding section (not illustrated). The cart terminal 87 includes a display device 78, an operation device 79, a scanner 88, and a card reader 89.

The display device 78 is configured by, for example, an LCD (Liquid Crystal Display) or an organic EL display and displays a screen generated according to an instruction of the control unit 56.

The operation device 79 is, for example, a touch panel stacked on a display surface of the display device 78. The operation device 79 acquires input operation of an operator and transmits the input operation to the control unit 56.

The scanner 88 reads code information (a barcode, a two-dimensional code, or the like) including a commodity code attached to a commodity.

If member information of the customer is registered not in the portable terminal 80 but in a member card, the card reader 89 reads registered content of the member card in which the member information is registered. If the customer performs credit card settlement, the card reader 89 reads credit card information

(Hardware Configuration of the Cart Terminal)

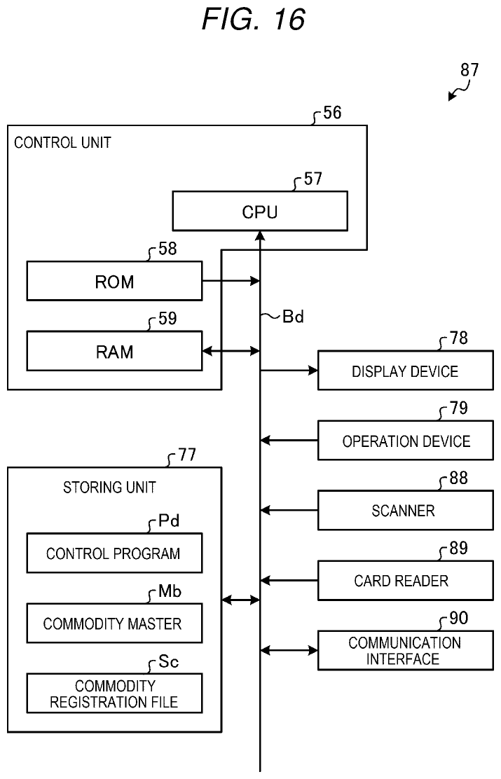

A hardware configuration of the cart terminal 87 is explained with reference to FIG. 16. FIG. 16 is a hardware block diagram illustrating an example of a hardware configuration of the cart terminal included in the shopping cart.

The cart terminal 87 includes a control unit 56 for controlling units. The control unit 56 includes a CPU 57, a ROM 58, and a RAM 59. The CPU 57 is connected to the ROM 58 and the RAM 59 via an internal bus Bd such as an address bus or a data bus. The CPU 57 loads, in the RAM 59, various programs stored in the ROM 58 and a storing unit 77. The CPU 57 operates according to the various programs loaded in the RAM 59 to control the cart terminal 87. That is, the control unit 56 has the configuration of the general computer.

The control unit 56 is connected to the storing unit 77, the display device 78, the operation device 79, the scanner 88, the card reader 89, and a communication interface 90 via the internal bus Bd.

The storing unit 77 is a storage device such as a HDD or an SSD. The storing unit 77 may be a nonvolatile memory such as a flash memory in which stored information is retained even if the cart terminal 87 is turned off. The storing unit 77 stores a control program Pd, the commodity master Mb, and a commodity registration file Sc.

The control program Pd is a program for controlling the operation of the entire cart terminal 87.

The commodity master Mb is as explained above (see FIG. 8). Since content of the commodity master Mb is updated at any time, the cart terminal 87 acquires the latest commodity master Mb, for example, from the store server 46.

The commodity registration file Sc is a file in which commodity information of commodities registered by the customer is recorded for each transaction.

The functions of the display device 78, the operation device 79, the scanner 88, and the card reader 89 are as explained above.

The communication interface 90 is an interface for communicating with the electronic receipt server 35 and the virtual POS server 36 via wireless communication by a wireless LAN or the like or wired communication via a wired LAN or the like.

(Hardware Configuration of the Virtual POS Server)

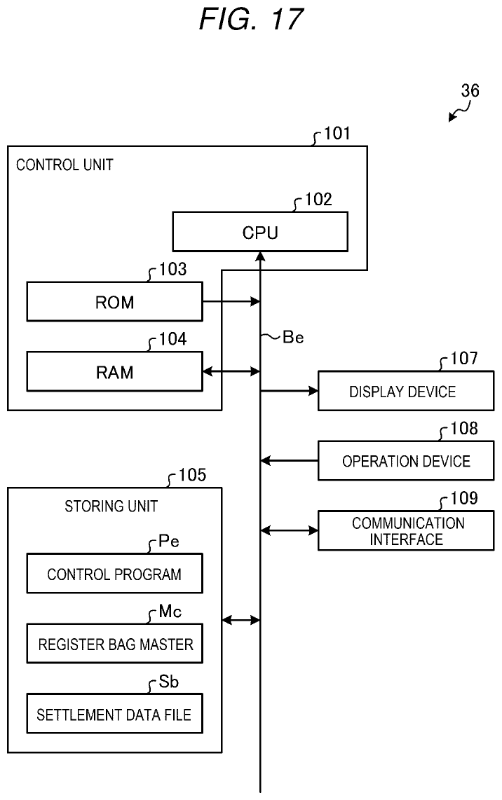

A hardware configuration of the virtual POS server 36 is explained with reference to FIG. 17. FIG. 17 is a functional block diagram illustrating an example of a hardware configuration of the virtual POS server included in the commodity storage support system according to the second embodiment.

The virtual POS server 36 includes a control unit 101 for controlling units. The control unit 101 includes a CPU 102, a ROM 103, and a RAM 104. The CPU 102 is connected to the ROM 103 and the RAM 104 via an internal bus Be such as an address bus or a data bus. The CPU 102 loads, in the RAM 104, various programs stored in the ROM 103 and a storing unit 105. The CPU 102 operates according to the various programs loaded in the RAM 104 to control the virtual POS server 36. That is, the control unit 101 has the configuration of the general computer.

The control unit 101 is connected to the storing unit 105, a display device 107, an operation device 108, and a communication interface 109 via the internal bus Be.

The storing unit 105 is a storage device such as a HDD or an SSD. The storing unit 105 may be a nonvolatile memory such as a flash memory in which stored information is retained even if the virtual POS server 36 is turned off. The storing unit 105 stores a control program Pe, the register bag master Mc, and a settlement data file Sb.

The control program Pe is a program for controlling the operation of the entire virtual POS server 36.

The register bag master Mc is as explained above (see FIG. 9).

The settlement data file Sb is a file indicating settlement content generated based on settlement processing performed by the cart terminal 87, the portable terminal 80, and the checkout machine 37. The settlement data file Sb is stored as sales information of the store.

The display device 107 displays, to an administrator and an operator of the virtual POS server 36, screen information generated by the control unit 101.

The operation device 108 acquires operation information of operation performed by the administrator and the operator of the virtual POS server 36 and outputs the operation information to the control unit 101.

The communication interface 109 is an interface for communicating with the cart terminal 87 and the checkout machine 37 via wireless communication by a wireless LAN or the like or wired communication by a wired LAN or the like.

(Hardware Configuration of the Checkout Machine)

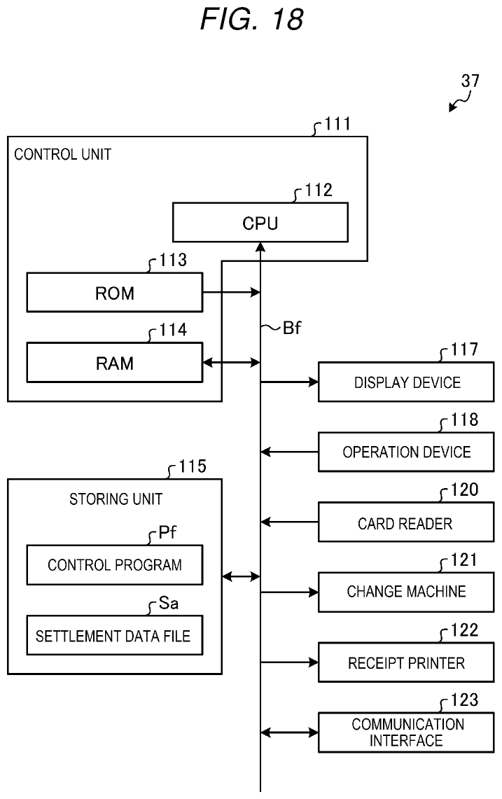

A hardware configuration of the checkout machine 37 is explained with reference to FIG. 18. FIG. 18 is a functional block diagram illustrating an example of a hardware configuration of the checkout machine included in the commodity storage support system according to the second embodiment.

The checkout machine 37 includes a control unit 111 for controlling units. The control unit 111 includes a CPU 112, a ROM 113, and a RAM 114. The CPU 112 is connected to the ROM 113 and the RAM 114 via an internal bus Bf such as an address bus or a data bus. The CPU 112 loads, in the RAM 114, various programs stored in the ROM 113 and a storing unit 115. The CPU 112 operates according to the various programs loaded in the RAM 114 to control the checkout machine 37. That is, the control unit 111 has the configuration of the general computer.

The control unit 111 is connected to the storing unit 115, a display device 117, an operation device 118, a card reader 120, a change machine 121, a receipt printer 122, and a communication interface 123 via the internal bus Bf.

The storing unit 115 is a storage device such as a HDD or an SSD. The storing unit 115 may be a nonvolatile memory such as a flash memory in which stored information is retained even if the checkout machine 37 is turned off. The storing unit 115 stores a control program Pf and the settlement data file Sa.

The control program Pf is a program for controlling the operation of the entire checkout machine 37.

The settlement data file Sa is information indicating settlement content generated based on settlement processing performed by the checkout machine 37.

The display device 117 displays, to the customer, screen information generated by the control unit 111.

The operation device 118 acquires operation information of operation performed by the customer and outputs the operation information to the control unit 111.

The card reader 120 reads, for example, registered content of a member card of the customer. The card reader 120 reads credit card information if the customer performs credit card settlement.

The change machine 121 counts deposited bills or coins if the customer performs cash settlement. If dispensing of change is necessary, the change machine 121 dispenses the change.

If dispensing of a paper receipt is necessary, the receipt printer 122 prints and dispenses the paper receipt.

The communication interface 123 is an interface for communicating with the electronic receipt server 35 and the virtual POS server 36 via wireless communication by a wireless LAN or the like or wired communication by a wired LAN or the like.

A hardware configuration of the electronic receipt server 35 is the same as the hardware configuration of the server device 20 (see FIG. 2) explained in the first embodiment. Therefore, explanation of the hardware configuration is omitted.

(Functional Configuration of the Cart Terminal)

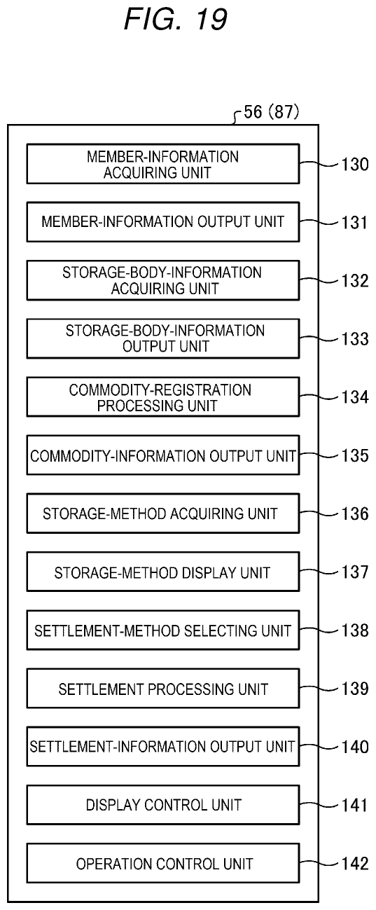

A functional configuration of the cart terminal 87 is explained with reference to FIG. 19. FIG. 19 is a functional block diagram illustrating an example of a functional configuration of the cart terminal included in the commodity storage support system according to the second embodiment.

The control unit 56 of the cart terminal 87 loads the control program Pd in the RAM 59 and causes the control program Pd to operate to thereby realize, as functional units, a member-information acquiring unit 130, a member-information output unit 131, a storage-body-information acquiring unit 132, a storage-body-information output unit 133, a commodity-registration processing unit 134, a commodity-information output unit 135, a storage-method acquiring unit 136, a storage-method display unit 137, a settlement-method selecting unit 138, a settlement processing unit 139, a settlement-information output unit 140, a display control unit 141, and an operation control unit 142 illustrated in FIG. 19.

The member-information acquiring unit 130 receives the member information Md of the electronic receipt system from the portable terminal 80 of the customer. Specifically, the cart terminal 87 reads, with the scanner 88, code information including the member information Md displayed on the display device 91 of the portable terminal 80. The member information Md may be transmitted and received by wireless communication between the portable terminal 80 and the cart terminal 87.

The member-information output unit 131 outputs the acquired member information Md to the virtual POS server 36.

The storage-body-information acquiring unit 132 acquires, based on selection operation of the customer, information relating to a storage body for storing purchased commodities. More specifically, the storage-body-information acquiring unit 132 acquires information indicating whether the purchased commodities are stored in a reusable shopping bag or stored in a purchased register bag or both of the reusable shopping bag and the register bag are used.

The storage-body-information output unit 133 outputs, to the virtual POS server 36, the information relating to the storage body acquired by the storage-body-information acquiring unit 132.

The commodity-registration processing unit 134 performs registration processing for reading, with the scanner 88, code information of a barcode or the like attached to a commodity to be purchased by the customer to thereby register the commodity.

The commodity-information output unit 135 outputs commodity information of the commodity registered by the commodity-registration processing unit 134 to the virtual POS server 36 every time the commodity is registered. If settlement processing in the checkout machine 37 is necessary, the commodity-information output unit 135 outputs the commodity information of the registered commodity to the checkout machine 37, for example, by wireless communication.

The storage-method acquiring unit 136 acquires, from the virtual POS server 36, a size of a register bag necessary for storing commodities registered at that point in time and a storage method for the commodities in the register bag.

The storage-method display unit 137 displays, on the display device 78, a storage method for storing commodities registered to that point, the storage method being acquired by the storage-method acquiring unit 136.

The settlement-method selecting unit 138 selects a settlement method such as credit card settlement, electronic money settlement, or cash settlement based on an operation instruction of the customer.

If the settlement method selected by the settlement-method selecting unit 138 is a settlement method executable in the cart terminal 87, the settlement processing unit 139 performs settlement processing for a total amount of the commodities registered by the commodity-registration processing unit 134. The settlement processing unit 139 outputs the settlement method to the checkout machine 37, for example, by wireless communication.

The settlement-information output unit 140 outputs settlement information indicating a result of settlement by the settlement processing unit 139 to the virtual POS server 36 and the electronic receipt server 35.

The display control unit 141 displays screen information generated by the control unit 56 to the customer.

The operation control unit 142 acquires operation information of operation performed by the customer and outputs the operation information to the control unit 56.

The functional configuration of the portable terminal 80 is the same as the functional configuration (see FIG. 7) explained in the first embodiment. Therefore, explanation of the functional configuration is omitted.

(Functional Configuration of the Virtual POS Server)

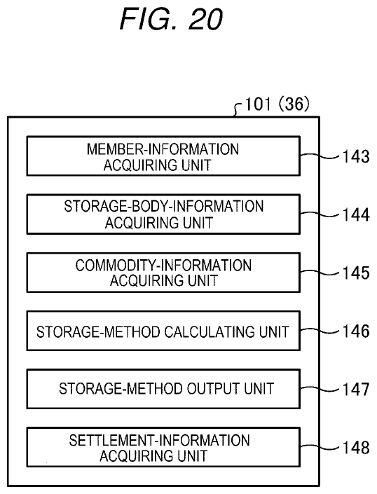

A functional configuration of the virtual POS server 36 is explained with reference to FIG. 20. FIG. 20 is a functional block diagram illustrating an example of a functional configuration of the virtual POS server included in the commodity storage support system according to the second embodiment.

The control unit 101 of the virtual POS server 36 loads the control program Pe in the RAM 104 and causes the control program Pe to operate to thereby realize, as functional units, a member-information acquiring unit 143, a storage-body-information acquiring unit 144, a commodity-information acquiring unit 145, a storage-method calculating unit 146, a storage-method output unit 147, and a settlement-information acquiring unit 148 illustrated in FIG. 20.

The member-information acquiring unit 143 acquires the member information Md of the customer from the cart terminal 87.

The storage-body-information acquiring unit 144 acquires, from the cart terminal 87, information relating to a storage body in which the customer stores purchased commodities.

Every time a commodity is registered in the cart terminal 87, the commodity-information acquiring unit 145 acquires commodity information from the cart terminal 87.

The storage-method calculating unit 146 calculates a size of a register bag necessary for storing commodities, commodity information of which is acquired by the commodity-information acquiring unit 145 to that point, and a storage method for the commodities. The storage-method calculating unit 146 calculates a method of storing settled commodities in a storage body, storage body information of which is acquired by the storage-body-information acquiring unit 144.

Every time a commodity is registered, the storage-method output unit 147 outputs, to the cart terminal 87, in a displayable manner, a storage method for storing commodities registered to that point. The storage-method output unit 147 outputs, to the cart terminal 87, in a displayable manner, a method for storing settled commodities in a designated storage body (a reusable shopping bag of the customer, a purchased register bag, or both of the reusable shopping bag and the register bag). The storage-method output unit 147 is an example of the information presenting unit in the present disclosure.

The settlement-information acquiring unit 148 acquires settlement information indicating a result of settlement from the cart terminal 87 or the checkout machine 37.

(Functional Configuration of the Checkout Machine)

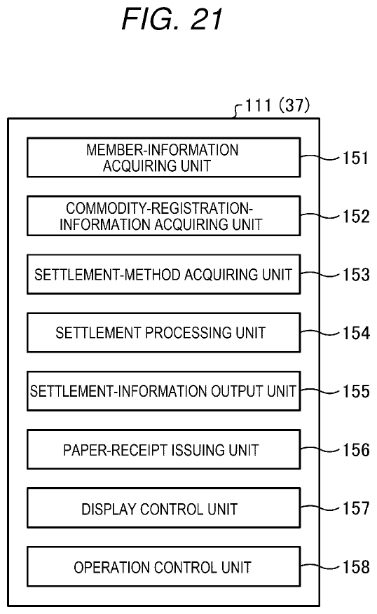

A functional configuration of the checkout machine 37 is explained with reference to FIG. 21. FIG. 21 is a functional block diagram illustrating an example of a functional configuration of the checkout machine included in the commodity storage support system according to the second embodiment.

The control unit 111 of the checkout machine 37 loads the control program Pf in the RAM 114 and causes the control program Pf to operate to thereby realize, as functional units, a member-information acquiring unit 151, a commodity-registration-information acquiring unit 152, a settlement-method acquiring unit 153, a settlement processing unit 154, a settlement-information output unit 155, a paper-receipt issuing unit 156, a display control unit 157, and an operation control unit 158 illustrated in FIG. 21.

The member-information acquiring unit 151 acquires, from the cart terminal 87, member information (for example, a member code) of a customer who performs settlement.

The commodity-registration-information acquiring unit 152 acquires, from the cart terminal 87, the commodity registration file Sc indicating a result of performing commodity registration. The commodity-registration-information acquiring unit 152 acquires the commodity registration file Sc from the cart terminal 87, for example, using wireless communication. The commodity-registration-information acquiring unit 152 may read, using a scanner not illustrated in FIG. 18, code information for specifying the commodity registration file Sc displayed on the display device 78 of the cart terminal 87 to thereby acquire the commodity registration file Sc from the cart terminal 87.

The settlement-method acquiring unit 153 acquires, from the cart terminal 87, a settlement method selected by the customer. The settlement-method acquiring unit 153 acquires the settlement method from the cart terminal 87, for example, by wireless communication.

The settlement processing unit 154 executes settlement processing with the designated settlement method. The settlement processing unit 154 generates the settlement data file Sa indicating a result of the settlement.

The settlement-information output unit 155 outputs the settlement data file Sa to the virtual POS server 36. For example, if the customer is a member of the electronic receipt system and it is necessary to generate an electronic receipt, the settlement-information output unit 155 outputs the settlement data file Sa to the electronic receipt server 35.

If the customer is not a member of the electronic receipt system, the paper-receipt issuing unit 156 issues a paper receipt indicating the settlement result.

The display control unit 157 displays screen information generated by the control unit 111 to the customer.

The operation control unit 158 acquires operation information of operation performed by the customer and outputs the operation information to the control unit 111.

(Functional Configuration of the Electronic Receipt Server)

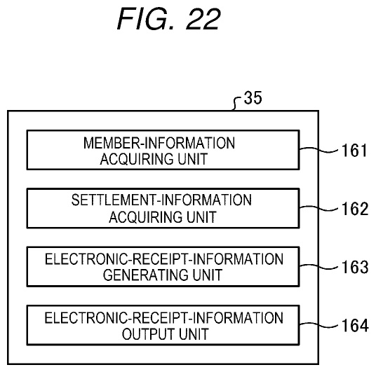

A functional configuration of the electronic receipt server 35 is explained with reference to FIG. 22. FIG. 22 is a functional block diagram illustrating an example of a functional configuration of the electronic receipt server included in the commodity storage support system according to the second embodiment.

A control unit of the electronic receipt server 35 loads a control program in a RAM and causes the control program to operate to thereby realize, as functional units, a member-information acquiring unit 161, a settlement-information acquiring unit 162, an electronic-receipt-information generating unit 163, and an electronic-receipt-information output unit 164 illustrated in FIG. 22.

The member-information acquiring unit 161 acquires, from the cart terminal 87, member information (for example, a member code) of a customer who performed settlement.

The settlement-information acquiring unit 162 acquires, from the cart terminal 87 or the checkout machine 37, settlement information indicating content of the settlement.

The electronic-receipt-information generating unit 163 generates computerized receipt information, that is, electronic receipt information based on the settlement information acquired by the settlement-information acquiring unit 162. The electronic-receipt-information generating unit 163 stores the generated electronic receipt information in the storing unit 25.

The electronic-receipt-information output unit 164 outputs the electronic receipt information to the portable terminal 80 of the customer.

(Flow of Processing Performed by the Commodity Storage Support System)

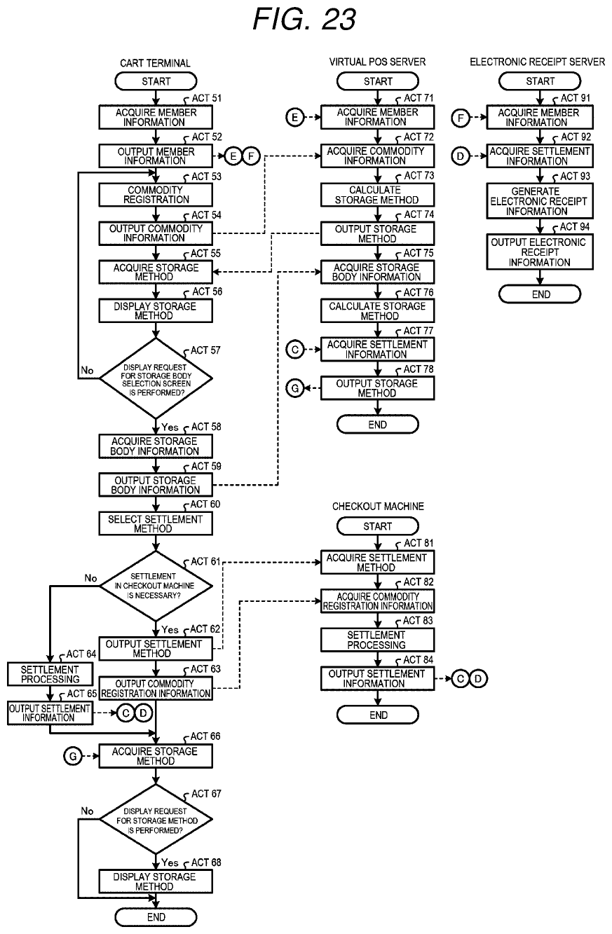

A flow of processing performed by the commodity storage support system 2 is explained separately for the cart terminal 87, the virtual POS server 36, the checkout machine 37, and the electronic receipt server 35. FIG. 23 is a flowchart illustrating an example of a flow of processing performed by the commodity storage support system according to the second embodiment.

(Flow of Processing Performed by the Cart Terminal)

For example, the member-information acquiring unit 130 reads, with the scanner 88, code information including the member information Md displayed on the display device 91 of the portable terminal 80 to thereby acquire the member information Md of the customer (Act 51). The member-information acquiring unit 130 may read, with the card reader 89, a member card carried by the customer and acquire the member information Md of the customer.

The member-information output unit 131 outputs the acquired member information Md to the virtual POS server 36 and the electronic receipt server 35 (Act 52).

The commodity registration processing unit 134 performs registration processing for reading, with the scanner 88, code information of a barcode or the like attached to a commodity to be purchased by the customer to thereby register the commodity (Act 53).

The commodity-information output unit 135 outputs commodity information of the commodity registered by the commodity-registration processing unit 134 to the virtual POS server 36 every time a commodity is registered (Act 54).

The storage-method acquiring unit 136 acquires, from the virtual POS server 36, a size of a register bag necessary for storing commodities registered at that point in time and a storage method for the commodities in the register bag (Act 55).

The storage-method display unit 137 displays, on the display device 78, a storage method for storing commodities registered to that point, the storage method being acquired by the storage-method acquiring unit 136 (Act 56).

The operation control unit 142 determines whether the customer performs operation for requesting display of a selection screen for a storage body (see FIG. 11) on the display device 78 (Act 57). If it is determined that the customer performs the operation for requesting the display of the election screen for the storage body (Yes in Act 57), the processing proceeds to Act 58. On the other hand, if it is not determined that the customer performs the operation for requesting the display of the selection screen for the storage body (No in Act 57), the processing returns to Act 53.

If it is determined in Act 57 that the customer performs the operation for requesting the display of the selection screen for the storage body, the storage-body-information acquiring unit 132 acquires storage body information selected based on an instruction of the customer on the selection screen for the storage body (Act 58).

The storage-body-information output unit 133 outputs the acquired storage body information to the virtual POS server 36 (Act 59).

The settlement-method selecting unit 138 selects, based on an operation instruction of the customer, a settlement method such as credit card settlement, electronic money settlement, or cash settlement (Act 60).

In order to perform settlement selected by the settlement-method selecting unit 138, the settlement processing unit 139 determines whether it is necessary to perform the settlement in the checkout machine 37 (Act 61). If it is determined that it is necessary to perform the settlement in the checkout machine 37 (Yes in Act 61), the processing proceeds to Act 62. On the other hand, if it is not determined that it is necessary to perform the settlement in the checkout machine 37 (No in Act 61), the processing proceeds to Act 64.

If it is determined in Act 61 that it is necessary to perform the settlement in the checkout machine 37, the settlement processing unit 139 outputs a settlement method to the checkout machine 37 (Act 62).

Subsequently, the commodity-information output unit 135 outputs the commodity information of the registered commodity to the checkout machine 37 (Act 63). Thereafter, the processing proceeds to Act 66.

On the other hand, if it is not determined in Act 61 that it is necessary to perform the settlement in the checkout machine 37, the settlement processing unit 139 performs settlement processing in the cart terminal 87 (Act 64).

Subsequently, the settlement-information output unit 140 outputs settlement information indicating a result of the settlement by the settlement processing unit 139 to the virtual POS server 36 and the electronic receipt server 35 (Act 65). Thereafter, the processing proceeds to Act 66.

The storage-method acquiring unit 136 acquires, from the virtual POS server 36, a storage method for storing all of registered commodities (Act 66).

The operation control unit 142 determines whether a display request for the storage method is performed by the operation device 79 of the cart terminal 87 (Act 67). If it is determined that the display request for the storage method is performed (Yes in Act 67), the processing proceeds to Act 68. On the other hand, it is not determined that the display request for the storage method is performed (No in Act 67), the cart terminal 87 ends the processing illustrated in FIG. 23.

If it is determined in Act 67 that the display request for the storage method is performed, the display control unit 141 displays a storage method for purchased commodities on the display device 78 of the cart terminal 87 (Act 68). Thereafter, the cart terminal 87 ends the processing illustrated in FIG. 23.

(Flow of Processing Performed by the Virtual POS Server)

The member-information acquiring unit 143 acquires the member information Md of the customer from the cart terminal 87 (Act 71).

Every time a commodity is registered in the cart terminal 87, the commodity-information acquiring unit 145 acquires commodity information from the cart terminal 87 (Act 72).

The storage-method calculating unit 146 calculates a size of a register bag necessary for storing commodities acquired by the commodity-information acquiring unit 145 to that point and a storage method for the commodities (Act 73).

The storage-method output unit 147 outputs, in a displayable manner, the storage method calculated in Act 73 to the cart terminal 87 (Act 74).

The storage-body-information acquiring unit 144 acquires storage body information from the cart terminal 87 (Act 75).

The storage-method calculating unit 146 calculates a method of storing all of registered commodities in a storage body, the storage body information of which is acquired in Act 75 (Act 76).

The settlement-information acquiring unit 148 acquires settlement information from the cart terminal 87 (Act 77).

The storage-method output unit 147 outputs, in a displayable manner, the storage method calculated in Act 76 to the cart terminal 87 (Act 78). Thereafter, the virtual POS server 36 ends the processing illustrated in FIG. 23.

(Flow of Processing Performed by the Checkout Machine)

The settlement-method acquiring unit 153 acquires, from the cart terminal 87, a settlement method selected by the customer (Act 81).

The commodity-registration-information acquiring unit 152 acquires, from the cart terminal 87, the commodity registration file Sc indicating a result of performing commodity registration (Act 82).

The settlement processing unit 154 executes settlement processing with the designated settlement method (Act 83).

Subsequently, the settlement-information output unit 155 outputs settlement information to the electronic receipt server 35 and the virtual POS server 36 (Act 84). Thereafter, the checkout machine 37 ends the processing illustrated in FIG. 23.

(Flow of Processing Performed by the Electronic Receipt Server)

The member-information acquiring unit 161 acquires member information from the cart terminal 87 (Act 91).

The settlement-information acquiring unit 162 acquires settlement information from the cart terminal 87 or the checkout machine 37 (Act 92).

The electronic-receipt-information generating unit 163 generates electronic receipt information based on the settlement information acquired in Act 92 (Act 93).

The electronic-receipt-information output unit 164 outputs the electronic receipt information generated by the electronic-receipt-information generating unit 163 to the portable terminal 80 of the customer (Act 94). Thereafter, the electronic receipt server 35 ends the processing illustrated in FIG. 23.

In the second embodiment, it is assumed that the customer is the member of the electronic receipt system.

However, if the customer is not a member of the electronic receipt system, the checkout machine 37 is caused to perform the settlement processing on condition that the cart terminal 87 cannot acquire member information. The paper-receipt issuing unit 156 of the checkout machine 37 issues a paper receipt indicating a settlement result.

(Action Effects of the Second Embodiment)

As explained above, in the commodity storage support system 2, it is possible to cause the cart terminal 87 (or the portable terminal 80) used by the customer, who is using the cart POS (or the smartphone POS), to present a storage method for commodities purchased by the user to the user. Therefore, the customer can store the commodities at the user's own pace while checking the presented storage method.

### Third Embodiment

A commodity storage support system 3 according to a third embodiment is explained with reference to the drawings.

(System Configuration of the Commodity Storage Support System)

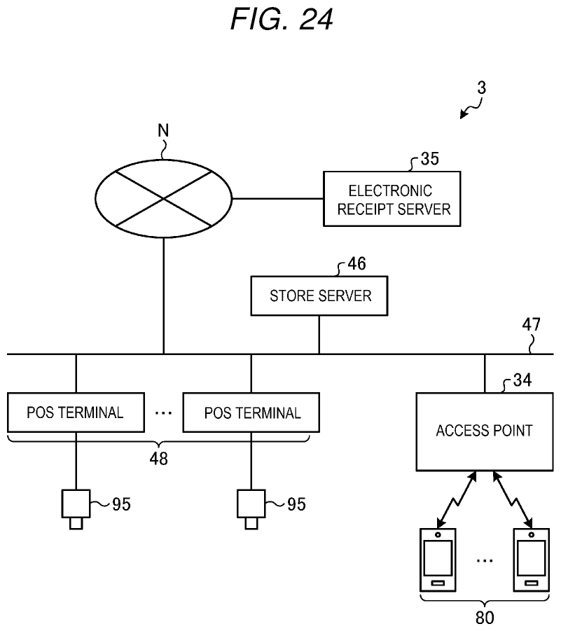

A system configuration of the commodity storage support system 3 is explained with reference to FIG. 24. FIG. 24 is a diagram illustrating a configuration example of the commodity storage support system according to the third embodiment.

The commodity storage support system 3 is a system that presents a storage method for purchased commodities to the portable terminal 80 carried by a customer in a store including a face-to-face type register with which a store clerk performs commodity registration and settlement processing or a semi-self-service register with which the store clerk performs the commodity registration and the customer performs the settlement operation.

The commodity storage support system 3 includes the electronic receipt server 35, POS terminals 48 and the store server 46 set in the store, and the portable terminals 80 carried by customers. It is assumed that a customer doing shopping is a member of the electronic receipt system who can receive, as a computerized receipt, with the portable terminal 80, settlement information relating to a commodity for which settlement is completed.

The electronic receipt server 35 generates electronic receipt information based on the settlement information transmitted from the POS terminal 48. The electronic receipt server 35 outputs the generated electronic receipt information to the portable terminal 80 of the customer who did shopping relating to the settlement information.

The POS terminal 48 performs registration processing for registering a commodity to be purchased by the customer and settlement processing for performing settlement relating to the registered commodity. As explained above, the commodity storage support system 3 may include, instead of the POS terminal 48, a registration machine with which the store clerk performs commodity registration and a checkout machine with which the customer performs settlement operation based on a registration result by the registration machine.

A plurality of POS terminals 48 are set in the store. A camera 95 is connected to each of the POS terminals 48. The camera 95 images, from above the POS terminal 48, a state in which, after the store clerk who performs registration operation takes out a commodity from a basket carried in by the customer and registers the commodity, the store clerk stores the commodity in another basket. The POS terminal 48 calculates a storage method for commodities based on a video captured by the camera 95. The POS terminal 48 is an example of the commodity storage support device in the present disclosure.

The store server 46 manages the operations of the plurality of POS terminals 48 set in the store. The store server 46 acquires the latest commodity master Mb (see FIG. 8) from a not-illustrated host server and outputs the latest commodity master Mb (see FIG. 8) to the POS terminals 48. Further, the store server 46 aggregates settlement information generated by the POS terminals 48 to thereby store the settlement information as sales information of the store.

The portable terminal 80 is carried by the customer and stores member information of the electronic receipt system. The portable terminal 80 acquires the electronic receipt information from the electronic receipt server 35. The portable terminal 80 acquires a storage method for purchased commodities from the POS terminal 48. Further, the portable terminal 80 displays, according to operation of the customer, the acquired electronic receipt information and the acquired storage method for commodities. Specifically, the portable terminal 80 is a smartphone, a tablet terminal, a personal computer, or the like.

The POS terminal 48 and the store server 46 are connected by the in-store network 47. The portable terminal 80 performs communication with the POS terminal 48 and the electronic receipt server 35 via the access point 34 connected to the in-store network 47.

A hardware configuration of the electronic receipt server 35 is the same as the hardware configuration of the server device 20 (see FIG. 2) explained in the first embodiment. Therefore, explanation of the hardware configuration is omitted. A hardware configuration of the POS terminal 48 is a configuration obtained by adding only the camera 95, which is peripheral equipment, to the hardware configuration of the POS terminal 40 (see FIG. 3) explained in the first embodiment. Therefore, explanation of the hardware configuration is omitted.

(Calculation Method for a Storage Method)

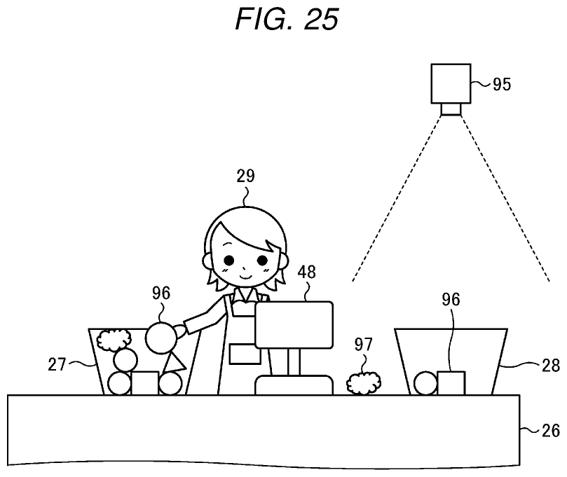

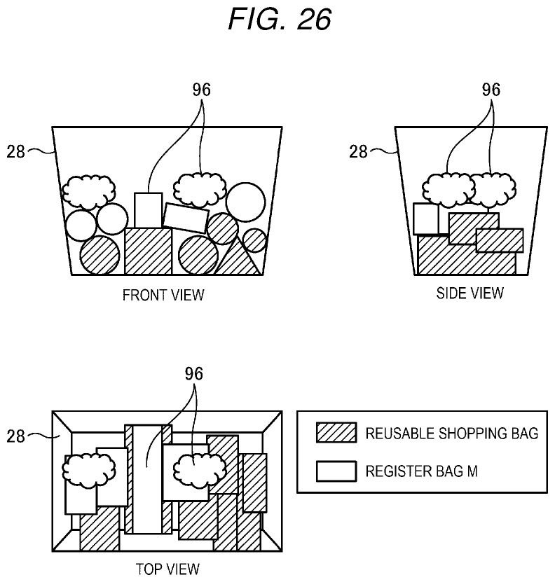

A calculation method for a storage method for commodities in this embodiment is explained with reference to FIGS. 25 and 26. FIG. 25 is a diagram for explaining a state in which a store clerk stores, in a basket, commodities registered in a POS terminal. FIG. 26 is a diagram for explaining a method of calculating a storage method for commodities.

In the POS terminal 48, a store clerk 29 takes out, one by one, commodities 96 stored in a basket 27 carried in by a customer and performs commodity registration. The store clerk 29 stores the commodities 96 for which the registration is completed in another basket 28. At this time, the store clerk 29 performs the storage while considering not to damage the commodities 96 as much as possible. That is, for example, the store clerk 29 stores heavy commodities earlier and stores light commodities later. Therefore, since a part of the commodities 96 taken out from the basket 27 and registered is stored later, the part of the commodities 96 is temporarily placed on a register table 26 (a commodity 97 illustrated in FIG. 25).

The customer carries the basket 28 storing the commodities 96 to a sacker table and stores the commodities 96 in a reusable shopping bag or a register bag.

At this time, the commodities 96 stored in the basket 28 are considered to satisfy the desirable storage conditions explained in the first embodiment. Therefore, if the customer performs storage, it is desirable to perform storage while simulating a storage state of the basket 28.

The camera 95 set above the POS terminal 48 images, as a moving image, a state in which the store clerk 29 is storing the commodities 96 and 97 in the basket 28. The POS terminal 48 outputs the captured moving image to the portable terminal 80 of the customer to be reproduceable. The customer stores the commodities taken out from the basket 28 in the reusable shopping bag or the register bag while viewing the reproduced moving image. Consequently, it is possible to easily simulate a storage method that is considered to be desirable.

Various variations are conceivable as a method of presenting information to the customer. The moving image captured by the camera 95 may be output to the portable terminal 80 in a displayable manner and reproduced in the portable terminal 80. In order to reduce a data amount, images segmented at a preset time interval from the moving image may be output to the portable terminal 80 in a displayable manner and reproduced in the portable terminal 80.

Since commodities stored in the basket 28 are registered in advance, by referring to the commodity master Mb, it is possible to acquire sizes and shapes of the commodities stored in the basket 28. Therefore, by analyzing an image captured by the camera 95, the POS terminal 48 can calculate which commodity is stored in which position of the basket 28. Consequently, the POS terminal 48 can create, for example, three views illustrated in FIG. 26.

FIG. 26 illustrates three views of the basket 28, in which the commodities 96 are stored, viewed from different three directions. Patterns simulating the commodities 96 are drawn in storage positions of the respective commodities 96. The POS terminal 48 outputs the three views to the portable terminal 80 in a displayable manner. The customer simulates a storage state of the commodities 96 and stores the commodities 96 in the reusable shopping bag and the register bag while viewing the three views in the portable terminal 80 of the customer.

The POS terminal 48 includes the function of calculating the storage method of the server device 20 explained in the first embodiment. Therefore, if not all of the commodities 96 stored in the basket 28 can be stored in one kind of a storage body, it is possible to perform an analysis for storing, in the reusable shopping bag, the commodities 96 stored in a lower part of the basket 28 and store, in the register bag, the commodities 96 stored in an upper part of the basket 28 as illustrated in FIG. 26.

(Functional Configuration of the POS Terminal)

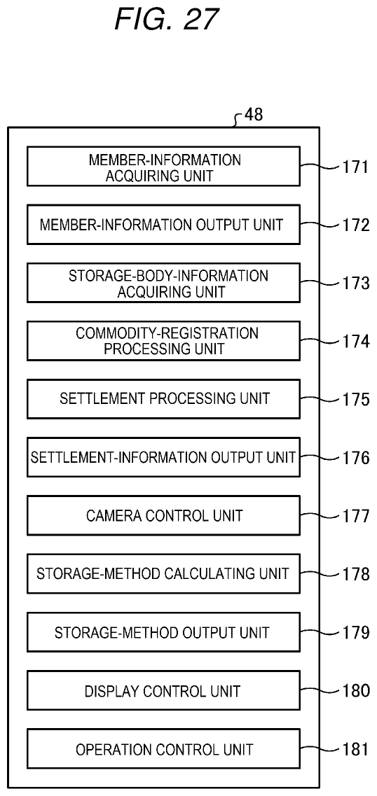

A functional configuration of the POS terminal 48 is explained with reference to FIG. 27. FIG. 27 is a functional block diagram illustrating an example of a functional configuration of the POS terminal included in the commodity storage support system according to the third embodiment.

The control unit 41 of the POS terminal 48 loads a control program in a RAM and causes the control program to operate to thereby realize, as functional units, a member-information acquiring unit 171, a member-information output unit 172, a storage-body-information acquiring unit 173, a commodity-registration processing unit 174, a settlement processing unit 175, a settlement-information output unit 176, a camera control unit 177, a storage-method calculating unit 178, a storage-method output unit 179, a display control unit 180, and an operation control unit 181 illustrated in FIG. 27.

The member-information acquiring unit 171 receives the member information Md of the electronic receipt system from the portable terminal 80 of the customer.

The member-information output unit 172 outputs the acquired member information Md to the electronic receipt server 35.

The storage-body-information acquiring unit 173 acquires, according to operation of the store clerk based on an instruction of the customer, information relating to a storage body used by the customer. The information relating to the storage body used by the customer is information indicating whether the customer stores a commodity in a register bag or stores the commodity in a reusable shopping bag or uses both of the register bag and the reusable shopping bag.

The commodity-registration processing unit 174 performs registration processing for reading, with the scanner 54, code information of a barcode or the like attached to a commodity to be purchased by the customer to thereby register the commodity.

The settlement processing unit 175 performs, on a total amount of commodities registered by the commodity-registration processing unit 174, settlement processing based on a payment method designated by the customer. The settlement processing unit 175 generates the settlement data file Sa indicating a result of the settlement and stores the settlement data file Sa in the storing unit 45.

The settlement-information output unit 176 outputs settlement information indicating the result of the settlement by the settlement processing unit 175 to the electronic receipt server 35.

The camera control unit 177 controls a recording operation of the camera 95.

The storage-method calculating unit 178 recognizes in which position of the basket 28 the store clerk stores which commodity. The storage-method calculating unit 178 calculates, based on the positions of commodities stored in the basket 28 and storage body information used by the customer, a method of storing, in a storage body, the commodities stored in the basket 28.

The storage-method output unit 179 outputs, in a displayable manner, the storage method calculated by the storage-method calculating unit 178 to the portable terminal 80. The storage-method output unit 179 outputs, in a displayable manner, a moving image recorded by the camera 95 to the portable terminal 80. It is determined in the POS terminal 48 based on an instruction of the store clerk or the customer what kind of information the storage-method output unit 179 outputs to the portable terminal 80.

The display control unit 180 generates a display screen to be displayed on the store clerk display device 51 or the customer display device 52 of the POS terminal 48. The display control unit 180 outputs the generated display screen to the store clerk display device 51 or the customer display device 52.

The operation control unit 181 acquires operation information of operation performed by the operation device 53 of the POS terminal 48 and passes the operation information to the control unit 41. The control unit 41 causes the POS terminal 48 to perform control corresponding to the acquired operation information.

The functional configuration of the electronic receipt server 35 is as explained in the second embodiment (see FIG. 22). The functional configuration of the portable terminal 80 is as explained in the first embodiment (see FIG. 7).

(Flow of Processing Performed by the Commodity Storage Support System)

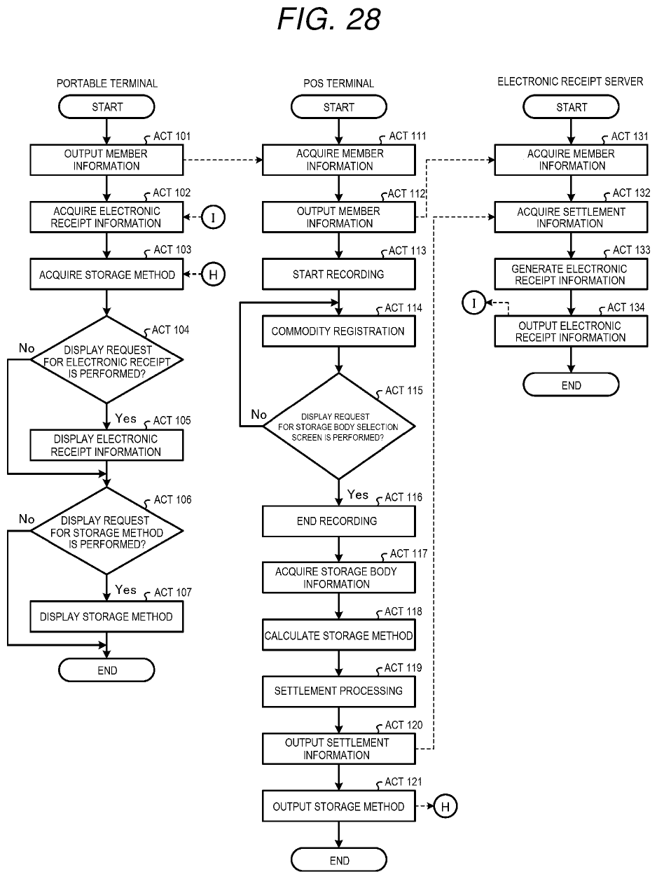

A flow of processing performed by the commodity storage support system 3 is explained separately for the portable terminal 80, the POS terminal 48, and the electronic receipt server 35 with reference to FIG. 28. FIG. 28 is a flowchart illustrating an example of a flow of processing performed by the commodity storage support system according to the third embodiment.

(Flow of Processing Performed by the Portable Terminal)

The member-information output unit 72 outputs the member information Md of the electronic receipt system to the POS terminal 48 (Act 101). As the output of the member information Md, an encoded member code may be displayed on the display device 91 of the portable terminal 80 or the member information Md may be transmitted from the portable terminal 80 to the POS terminal 48 by wireless communication or the like.

If settlement ends, the electronic-receipt-information acquiring unit 73 acquires electronic receipt information from the electronic receipt server 35 (Act 102). Specifically, the electronic-receipt-information acquiring unit 73 operates a dedicated application such as an electronic receipt application installed in the portable terminal 80 to thereby acquire the electronic receipt information from the electronic receipt server 35 based on an identification code or a member code of the application.

Subsequently, the storage-method acquiring unit 74 acquires a storage method for commodities from the POS terminal 48 (Act 103).

The operation control unit 76 determines whether a display request for an electronic receipt is performed by the operation device 92 of the portable terminal 80 (Act 104). If it is determined that the display request for the electronic receipt is performed (Yes in Act 104), the processing proceeds to Act 105. On the other hand, if it is not determined that the display request for the electronic receipt is performed (No in Act 104), the processing proceeds to Act 106.

If it is determined in Act 104 that the display request for the electronic receipt is performed, the display control unit 75 displays the electronic receipt information on the display device 91 of the portable terminal 80 (Act 105).

If it is not determined in Act 104 that the display request for the electronic receipt is performed or subsequent to Act 105, the operation control unit 76 determines whether a display request for a storage method is performed by the operation device 92 of the portable terminal 80 (Act 106). If it is determined that the display request for the storage method is performed (Yes in Act 106), the processing proceeds to Act 107. On the other hand, if it is not determined that the display request for the storage method is performed (No in Act 106), the portable terminal 80 ends the processing illustrated in FIG. 28.

If it is determined in Act 106 that the display request for the storage method is performed, the display control unit 75 displays a storage method for purchased commodities on the display device 91 of the portable terminal 80 (Act 107). The storage method for the commodities may be browsed by a dedicated application installed in the portable terminal 80. Thereafter, the portable terminal 80 ends the processing illustrated in FIG. 28.

(Flow of Processing Performed by the POS Terminal)

The member-information acquiring unit 171 acquires the member information Md of the customer from the portable terminal 80 (Act 111).

The member-information output unit 172 outputs the member information Md of the customer to the electronic receipt server 35 (Act 112).

The camera control unit 177 starts recording by the camera 95 (Act 113).

The commodity-registration processing unit 174 performs commodity registration processing for reading, with the scanner 54, code information of a barcode or the like attached to a commodity to be purchased by the customer and registering the commodity corresponding to the read code information (Act 114).

The operation control unit 181 determines whether the store clerk performs operation for requesting display of a selection screen for a storage body (see FIG. 11) on the store clerk display device 51 (Act 115). If it is determined that the store clerk performs the operation for requesting the display of the selection screen for the storage body (Yes in Act 115), the processing proceeds to Act 116. On the other hand, it is not determined that the store clerk performs the operation for requesting the display of the selection screen for the storage body (No in Act 115), the processing returns to Act 114.

If it is determined in Act 115 that the store clerk performs the operation for requesting the display of the selection screen for the storage body, the camera control unit 177 ends the recording by the camera 95 (Act 116).

The storage-body-information acquiring unit 173 acquires storage body information selected based on an instruction of the customer on the selection screen for the storage body (Act 117).

The storage-method calculating unit 178 specifies the positions of commodities stored in the basket 28 to thereby calculate a storage state of the commodities. The storage-method calculating unit 178 creates, based on the calculated storage method and the storage body information, for example, the three views illustrated in FIG. 26 (Act 118).

The settlement processing unit 175 performs, on a total amount of commodities registered by the commodity-registration processing unit 174, settlement processing based on the payment method designated by the customer (Act 119). The settlement processing unit 175 generates the settlement data file Sa indicating a result of the settlement and stores the settlement data file Sa in the storing unit 45.

The settlement-information output unit 176 outputs settlement information indicating the result of the settlement to the electronic receipt server 35 (Act 120).

The storage-method output unit 179 outputs the storage method calculated by the storage-method calculating unit 178 to the portable terminal 80 (Act 121). The storage-method calculating unit 178 may output a moving image captured by the camera 95 to the portable terminal 80. Thereafter, the POS terminal 48 ends the processing illustrated in FIG. 28.

(Flow of Processing Performed by the Electronic Receipt Server)

The member-information acquiring unit 161 acquires member information from the POS terminal 48 (Act 131).

The settlement-information acquiring unit 162 acquires settlement information from the POS terminal 48 (Act 132).

The electronic-receipt-information generating unit 163 generates electronic receipt information based on the settlement information acquired in Act 132 (Act 133).

The electronic-receipt-information output unit 164 outputs the electronic receipt information generated by the electronic-receipt-information generating unit 163 to the portable terminal 80 of the customer (Act 134). Thereafter, the electronic receipt server 35 ends the processing illustrated in FIG. 28.

(Action Effects of the Third Embodiment)

As explained above, in the POS terminal 48 (the commodity storage support device) in the third embodiment, if the store clerk registers commodities purchased by the customer, the storage-method calculating unit 178 calculates a storage method for the commodities based on an image obtained by the store clerk imaging the basket 28 storing the registered commodities. Therefore, since a storage method in the storage body is calculated with reference to a storage state of the basket 28, it is possible to simplify the processing performed by the storage-method calculating unit 178 compared with the other embodiments.

The embodiments are explained above. However, these embodiments are presented as examples and are not intended to limit the scope of invention. The new embodiments can be carried out in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. A commodity storage support device, comprising:
a commodity-information acquiring component configured to acquire information relating to storage of registered commodities;
a storage-body-information acquiring component configured to acquire information relating to a storage body for storing commodities purchased by a customer;
a storage-method calculating component configured to calculate a storage method in storing the commodities in the storage body; and
an information presenting component configured to output, in a displayable manner, the storage method to a portable terminal carried by the customer.

2. The commodity storage support device according to claim 1, wherein the storage method calculated by the storage-method calculating component includes storage order and a storage position in storing the commodities in the storage body.

3. The commodity storage support device according to claim 1, wherein the information presenting component outputs the storage method and information indicating a settlement result of the commodities to the portable terminal in a displayable manner.

4. The commodity storage support device according to claim 1, wherein, if a store clerk registers the commodities purchased by the customer, the storage-method calculating component calculates the storage method for the commodities based on an image obtained by the store clerk imaging a basket storing the registered commodities.

5. The commodity storage support device according to claim 1, wherein the storage body is a storage bag purchased by the customer or a reusable shopping bag carried by the customer.

6. The commodity storage support device according to claim 1, wherein the storage-body-information acquiring component is further configured to acquire information relating to at least one of a load and a size of the storage body.

7. A commodity storage support method, comprising:
acquiring information relating to storage of registered commodities;
acquiring information relating to a storage body for storing commodities purchased by a customer;
calculating a storage method in storing the commodities in the storage body; and
outputting, in a displayable manner, the storage method to a portable terminal carried by the customer.

8. The commodity storage support method according to claim 7, further comprising:
calculating a storage order and a storage position in storing the commodities in the storage body.

9. The commodity storage support method according to claim 7, further comprising:
outputting the storage method and information indicating a settlement result of the commodities to the portable terminal in a displayable manner.

10. The commodity storage support method according to claim 7, further comprising:
if a store clerk registers the commodities purchased by the customer, calculating the storage method for the commodities based on an image obtained by the store clerk imaging a basket storing the registered commodities.

11. The commodity storage support method according to claim 7, wherein the storage body is a storage bag purchased by the customer or a reusable shopping bag carried by the customer.

12. The commodity storage support method according to claim 7, further comprising:
acquiring information relating to at least one of a load and a size of the storage body.

13. A commodity storage support system, comprising:
a plurality of POS terminals, each POS terminal configured to perform registration processing and settlement processing; and
a store server connected to the plurality of POS terminals by a network, the store server comprising:
a commodity-information acquiring component configured to acquire information relating to storage of registered commodities;
a storage-body-information acquiring component configured to acquire information relating to a storage body for storing commodities purchased by a customer;
a storage-method calculating component configured to calculate a storage method in storing the commodities in the storage body; and
an information presenting component configured to output, in a displayable manner, the storage method to a portable terminal carried by the customer.

14. The commodity storage support system according to claim 13, wherein the store server is connected to the plurality of POS terminals by a wireless network or a wired network.

15. The commodity storage support system according to claim 13, wherein the wherein the store server is connected to the portable terminal by a wireless network.

16. The commodity storage support system according to claim 13, wherein the storage method calculated by the storage-method calculating component includes storage order and a storage position in storing the commodities in the storage body.

17. The commodity storage support system according to claim 13, wherein the information presenting component outputs the storage method and information indicating a settlement result of the commodities to the portable terminal in a displayable manner.

18. The commodity storage support system according to claim 13, wherein, if a store clerk registers the commodities purchased by the customer, the storage-method calculating component calculates the storage method for the commodities based on an image obtained by the store clerk imaging a basket storing the registered commodities.

19. The commodity storage support system according to claim 13, wherein the storage body is a storage bag purchased by the customer or a reusable shopping bag carried by the customer.

20. The commodity storage support system according to claim 13, wherein the storage-body-information acquiring component is further configured to acquire information relating to at least one of a load and a size of the storage body.
